(19) United States
(12) Patent Application Publication
(10) Pub. No.: US 2015/0351168 A1
(43) Pub. Date: Dec. 3, 2015

(54) LIGHT-EMITTING DEVICE AND ELECTRONIC DEVICE

(71) Applicant: Semiconductor Energy Laboratory Co., Ltd., Atsugi-shi (JP)

(72) Inventors: Seiji YASUMOTO, Tochigi (JP); Masataka SATO, Tochigi (JP); Saki OBANA, Tochigi (JP); Junpei YANAKA, Tochigi (JP); Koichi TAKESHIMA, Sano (JP); Minato ITO, Tokyo (JP); Kohei YOKOYAMA, Fujisawa (JP)

(21) Appl. No.: 14/725,071

(22) Filed: May 29, 2015

(30) Foreign Application Priority Data
May 30, 2014 (JP) 2014-111985
Jul. 10, 2014 (JP) 2014-142077

(51) Int. Cl. H05B 33/04; H05B 33/12; B32B 17/06

(52) U.S. Cl. CPC H05B 33/04; B32B 17/06; H05B 33/12; B32B 2255/20; B32B 2457/206; B32B 2457/00

(57) ABSTRACT

A highly reliable light-emitting device is provided. A light-emitting device with high resistance to repeated bending is provided. A light-emitting device in which cracks are less likely to occur even in a high-temperature and high-humidity environment is provided. The light-emitting device includes a light-emitting element between a pair of insulating layers. The pair of insulating layers is sandwiched between a pair of bonding layers. The pair of bonding layers is sandwiched between a pair of flexible substrates. At least one of the insulating layers has compressive stress. At least one of the bonding layers has a glass transition temperature higher than or equal to 60° C. At least one of the substrates has a coefficient of linear expansion less than or equal to 60 ppm/K.

### BACKGROUND OF THE INVENTION

1. Field of the Invention

One embodiment of the present invention relates to a light-emitting device, an input/output device, and an electronic device, and particularly to a flexible light-emitting device, a flexible input/output device, and a flexible electronic device.

Note that one embodiment of the present invention is not limited to the above technical field. One embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification can include a semiconductor device, a display device, a light-emitting device, a power storage device, a storage device, an electronic device, a lighting device, an input device (e.g., a touch sensor), an output device, an input/output device (e.g., a touch panel), a method for driving any of them, and a method for manufacturing any of them.

2. Description of the Related Art

Light-emitting elements utilizing electroluminescence (also referred to as EL elements) have features of the ease of being thinner and lighter, high speed response to input signals, and capability of DC low voltage driving and have been expected to be applied to display devices and lighting devices.

Furthermore, a flexible device in which a functional element such as a semiconductor element, a display element, or a light-emitting element is provided over a substrate having flexibility (hereinafter also referred to as a flexible substrate) has been developed. Typical examples of the flexible device include, as well as a lighting device and an image display device, a variety of semiconductor circuits including a semiconductor element such as a transistor.

Patent Document 1 discloses a flexible active matrix light-emitting device in which an organic EL element and a transistor serving as a switching element are provided over a film substrate.

Display devices are expected to be applied to a variety of uses and become diversified. For example, a smartphone and a tablet terminal with a touch panel are being developed as portable information terminals.

### REFERENCE

### Patent Document

### [Patent Document 1] Japanese Published Patent Application No. 2003-174153

### SUMMARY OF THE INVENTION

An object of one embodiment of the present invention is to provide a novel device such as a semiconductor device, a light-emitting device, a display device, an input/output device, an electronic device, or a lighting device. Another object of one embodiment of the present invention is to provide a highly reliable device. Another object of one embodiment of the present invention is to provide a device with high resistance to repeated bending. Another object of one embodiment of the present invention is to provide a device in which cracks are less likely to occur even in a high-temperature and high-humidity environment. Another object of one embodiment of the present invention is to provide a device which is lightweight, thin, or flexible.

Another object of one embodiment of the present invention is to inhibit occurrence of a crack in films of a device. Another object of one embodiment of the present invention is to improve a yield in a manufacturing process of a device. Another object of one embodiment of the present invention is to provide a method for manufacturing a device with high mass productivity.

Note that the descriptions of these objects do not disturb the existence of other objects. In one embodiment of the present invention, there is no need to achieve all the objects. Other objects will be apparent from and can be derived from the description of the specification, the drawings, the claims, and the like.

A light-emitting device of one embodiment of the present invention includes a light-emitting element between a pair of insulating layers. The pair of insulating layers is sandwiched between a pair of bonding layers. The pair of bonding layers is sandwiched between a pair of flexible substrates. At least one of the insulating layers has compressive stress. At least one of the bonding layers has a glass transition temperature higher than or equal to 60° C., preferably higher than or equal to 80° C. At least one of the flexible substrates has a coefficient of linear expansion less than or equal to 60 ppm/K, preferably less than or equal to 30 ppm/K and further preferably less than or equal to 20 ppm/K.

Alternatively a light-emitting device of one embodiment of the present invention includes a first substrate, a second substrate, an element layer, a first insulating layer, a second insulating layer, a first bonding layer, and a second bonding layer. The first substrate is flexible. The second substrate is flexible. The element layer is positioned between the first substrate and the second substrate. The element layer includes a light-emitting element. The first insulating layer is positioned between the first substrate and the element layer. The second insulating layer is positioned between the second substrate and the element layer. The first bonding layer is positioned between the first substrate and the first insulating layer. The second bonding layer is positioned between the second substrate and the second insulating layer. At least one of the first insulating layer and the second insulating layer has a stress of a negative value. A glass transition temperature of at least one of the first bonding layer and the second bonding layer is higher than or equal to 60° C., preferably higher than or equal to 80° C. A coefficient of linear expansion of at least one of the first substrate and the second substrate is less than or equal to 60 ppm/K, preferably less than or equal to 30 ppm/K and further preferably less than or equal to 20 ppm/K.

Note that in any of the above structures, at least part of the first insulating layer or the second insulating layer has compressive stress. In other words, the first insulating layer includes a first portion, the second insulating layer includes a second portion, and at least one of the first portion and the second portion has compressive stress. It is particularly preferable that both the first portion and the second portion have compressive stress.

Similarly, a glass transition temperature of at least part of a bonding layer or a substrate, a coefficient of linear expansion of at least part of a bonding layer or a substrate, a thickness of at least part of a substrate, stress or transmittance of at least part of an insulating layer, and the like, which will be described in this specification, are included in numerical ranges described herein.

In any of the above structures, a coefficient of linear expansion of at least one of the first bonding layer and the second bonding layer is preferably less than or equal to 100 ppm/K and further preferably less than or equal to 70 ppm/K.

In any of the above structures, a glass transition temperature of at least one of the first substrate and the second substrate is preferably higher than or equal to 150° C., further preferably higher than or equal to 200° C., and still further preferably higher than or equal to 250° C.

In any of the above structures, a thickness of at least one of the first substrate and the second substrate is preferably greater than or equal to 1 μm and less than or equal to 100 μm and further preferably greater than or equal to 1 μm and less than or equal to 25 μm.

In any of the above structures, stress of at least one of the first insulating layer and the second insulating layer is preferably higher than or equal to −500 MPa and lower than 0 MPa, further preferably higher than or equal to −250 MPa and lower than 0 MPa, still further preferably higher than or equal to −250 MPa and lower than −15 MPa, and particularly preferably higher than or equal to −100 MPa and lower than −15 MPa.

In any of the above structures, transmittance of light in a visible region in at least one of the first insulating layer and the second insulating layer is preferably greater than or equal to 80% and further preferably greater than or equal to 85% on the average.

In any of the above structures, transmittance of light having a wavelength of 475 nm in at least one of the first insulating layer and the second insulating layer is preferably greater than or equal to 70%, further preferably greater than or equal to 80%, and still further preferably greater than or equal to 85%.

In any of the above structures, transmittance of light having a wavelength of 650 nm in at least one of the first insulating layer and the second insulating layer is preferably greater than or equal to 70%, further preferably greater than or equal to 80%, and still further preferably greater than or equal to 85%.

In any of the above structures, it is preferable that at least one of the first insulating layer and the second insulating layer include oxygen, nitrogen, and silicon, for example, silicon oxynitride.

In any of the above structures, it is preferable that at least one of the first insulating layer and the second insulating layer include silicon nitride or silicon nitride oxide.

In any of the above structures, it is preferable that at least one of the first insulating layer and the second insulating layer include a silicon oxynitride film and a silicon nitride film, and that the silicon oxynitride film and the silicon nitride film be in contact with each other.

Embodiments of the present invention also include an electronic device including the light-emitting device having any of the above structures and a lighting device including the light-emitting device having any of the above structures. For example, one embodiment of the present invention is an electronic device including the light-emitting device having any of the above structures; and an antenna, a battery, a housing, a speaker, a microphone, or an operation button.

Note that the light-emitting device or the input/output device of one embodiment of the present invention in this specification and the like may include, in its category, modules such as a module provided with a connector such as a flexible printed circuit (FPC) or a tape carrier package (TCP) and a module directly mounted with an integrated circuit (IC) by a chip on glass (COG) method or the like. Alternatively, these modules may include, in its category, the light-emitting device or the input/output device of one embodiment of the present invention.

According to one embodiment of the present invention, a novel device such as a semiconductor device, a light-emitting device, a display device, an input/output device, an electronic device, or a lighting device can be provided. According to one embodiment of the present invention, a highly reliable device can be provided. According to one embodiment of the present invention, a device with high resistance to repeated bending can be provided. According to one embodiment of the present invention, a device in which cracks are less likely to occur even in a high-temperature and high-humidity environment can be provided. According to one embodiment of the present invention, a device which is lightweight, thin, or flexible can be provided.

According to one embodiment of the present invention, occurrence of a crack in films of a device can be inhibited. According to one embodiment of the present invention, yield in a manufacturing process of a device can be improved. According to one embodiment of the present invention, a method for manufacturing a device with high mass productivity can be provided.

Note that the description of these effects does not disturb the existence of other effects. One embodiment of the present invention does not necessarily achieve all the above effects. Other effects will be apparent from and can be derived from the description of the specification, the drawings, the claims, and the like.

### BRIEF DESCRIPTION OF THE DRAWINGS

FIGS. 1A1 and 1A2, 1B, 1C, and 1D illustrate examples of a light-emitting device.

FIGS. 2A to 2C illustrate examples of a light-emitting device.

FIGS. 3A and 3B illustrate examples of a light-emitting device.

FIGS. 4A to 4C illustrate an example of an input/output device.

FIGS. 5A and 5B illustrate an example of an input/output device.

FIGS. 6A to 6C illustrate examples of an input/output device.

FIGS. 7A to 7C illustrate examples of an input/output device.

FIG. 8 illustrates an example of an input/output device.

FIG. 9 illustrates an example of an input/output device.

FIGS. 10A to 10G illustrate examples of electronic devices and lighting devices.

FIGS. 11A to 11I illustrate examples of electronic devices.

FIGS. 12A to 12F illustrate samples of Example 1, a method of a bending test, and samples of Example 2.

FIG. 13 shows the results of calculating transmittance of light in samples in Example 2.

FIG. 14 shows the results of calculating transmittance of light in samples in Example 2.

### DETAILED DESCRIPTION OF THE INVENTION

Embodiments will be described in detail with reference to drawings. Note that the present invention is not limited to the description below, and it is easily understood by those skilled in the art that various changes and modifications can be made without departing from the spirit and scope of the present invention. Accordingly, the present invention should not be interpreted as being limited to the content of the embodiments below.

Note that in the structures of the invention described below, the same portions or portions having similar functions are denoted by the same reference numerals in different drawings, and description of such portions is not repeated. Furthermore, the same hatching pattern is used for portions having similar functions, and the portions are not especially denoted by reference numerals in some cases.

In addition, the position, size, range, or the like of each structure illustrated in drawings and the like is not accurately represented in some cases for easy understanding. Therefore, the disclosed invention is not necessarily limited to the position, size, range, or the like disclosed in the drawings and the like.

### Embodiment 1

In this embodiment, a light-emitting device of one embodiment of the present invention will be described with reference to drawings. Although a light-emitting device mainly including an organic EL element is described in this embodiment as an example, one embodiment of the present invention is not limited to this example. A light-emitting device or a display device including another light-emitting element or display element which will be described later in this embodiment as an example is also one embodiment of the present invention. Moreover, one embodiment of the present invention is not limited to the light-emitting device or the display device and can be applied to a variety of devices such as a semiconductor device and an input/output device.

A layer to be peeled can be formed over a formation substrate, peeled from the formation substrate, and then transferred to another substrate. With this method, for example, a layer to be peeled which is formed over a formation substrate having high heat resistance can be transferred to a substrate having low heat resistance. Therefore, the manufacturing temperature of the layer to be peeled is not limited by the substrate having low heat resistance. Moreover, the layer to be peeled can be transferred to a substrate or the like which is more lightweight and flexible and thinner than the formation substrate, whereby a variety of devices such as a semiconductor device, a light-emitting device, a display device, and an input/output device can be made lightweight, flexible, and thin.

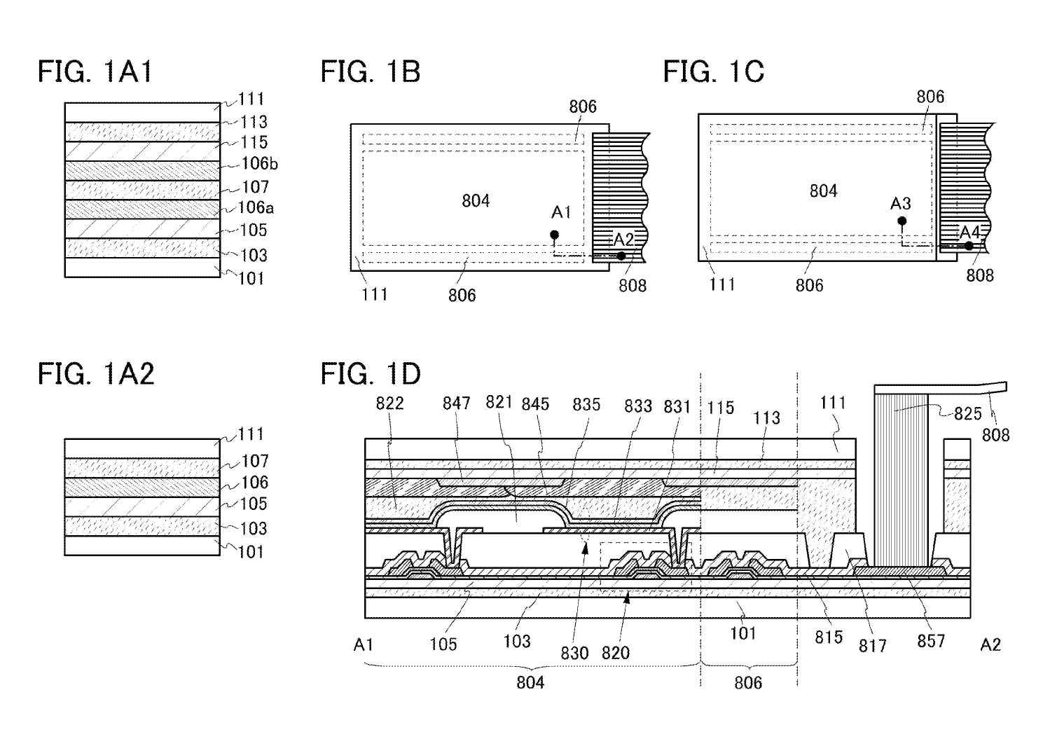

FIGS. 1A1 and 1A2 illustrate structure examples of a light-emitting device of this embodiment.

A light-emitting device illustrated in FIG. 1A1 includes a substrate 101, a bonding layer 103, an insulating layer 105, an element layer 106a, a bonding layer 107, a functional layer 106b, an insulating layer 115, a bonding layer 113, and a substrate 111. The substrates 101 and 111 are flexible. The element layer 106a includes at least one functional element. Examples of the functional element include a semiconductor element such as a transistor; a light-emitting element such as a light-emitting diode, an inorganic EL element, and an organic EL element; and a display element such as a liquid crystal element. The functional layer 106b includes, for example, a coloring layer (e.g., a color filter), a light-blocking layer (e.g., a black matrix), or the above functional element.

An example of a method for manufacturing the light-emitting device illustrated in FIG. 1A1 is shown here. First, a peeling layer is formed over a formation substrate, the insulating layer 105 is formed over the peeling layer, and the element layer 106a is formed over the insulating layer 105. In addition, a peeling layer is formed over another formation substrate, the insulating layer 115 is formed over the peeling layer, and the functional layer 106b is formed over the insulating layer 115. Then, the element layer 106a and the functional layer 106b are attached to each other so as to face each other with the bonding layer 107 provided therebetween. The formation substrate is separated from the insulating layer 105 with the peeling layer, and the insulating layer 105 is attached to the substrate 101 with the bonding layer 103. Similarly, the other formation substrate is separated from the insulating layer 115 with the peeling layer, and the insulating layer 115 is attached to the substrate 111 with the bonding layer 113. In the above manner, the light-emitting device illustrated in FIG. 1A1 can be manufactured.

Note that after the formation substrates are each separated from the insulating layer, the peeling layer may remain on the formation substrate side or the insulating layer side. As the peeling layer, an inorganic material or an organic resin can be used. Examples of the inorganic material include a metal, an alloy, a compound, and the like that contain any of the following elements: tungsten, molybdenum, titanium, tantalum, niobium, nickel, cobalt, zirconium, zinc, ruthenium, rhodium, palladium, osmium, iridium, and silicon. For example, a stacked-layer structure including a layer containing tungsten and a layer containing an oxide of tungsten can be employed for the peeling layer. Examples of the organic resin include polyimide, polyester, polyolefin, polyamide, polycarbonate, and acrylic. Note that the organic resin may be used as the layer (e.g., the substrate) of the device. Alternatively, the organic resin may be removed and another substrate may be attached to the exposed surface of the layer to be peeled using an adhesive.

A light-emitting device illustrated in FIG. 1A2 includes the substrate 101, the bonding layer 103, the insulating layer 105, an element layer 106, the bonding layer 107, and the substrate 111.

An example of a method for manufacturing the light-emitting device illustrated in FIG. 1A2 is shown here. First, a peeling layer is formed over a formation substrate, the insulating layer 105 is formed over the peeling layer, the element layer 106 is formed over the insulating layer 105, and the element layer 106 and the substrate 111 are attached to each other with the bonding layer 107. The formation substrate is separated from the insulating layer 105 with the peeling layer, and the insulating layer 105 is attached to the substrate 101 with the bonding layer 103. In the above manner, the light-emitting device illustrated in FIG. 1A2 can be manufactured.

For example, an organic EL element is likely to deteriorate due to moisture or the like; therefore, reliability might be insufficient when the organic EL element is formed over an organic resin substrate having a poor moisture-proof property. Here, according to the above manufacturing methods, a protective film having an excellent moisture-proof property (corresponding to the insulating layer 105 and/or the insulating layer 115) is formed over a glass substrate at a high temperature, whereby the protective film can be transferred to a flexible organic resin substrate having low heat resistance and a poor moisture-proof property. A highly reliable flexible light-emitting device can be manufactured by forming an organic EL element over the protective film transferred to the organic resin substrate.

Another example is as follows: after a protective film having an excellent moisture-proof property is formed over a glass substrate at a high temperature and an organic EL element is formed over the protective film, the protective film and the organic EL element can be peeled from the glass substrate and transferred to a flexible organic resin substrate having a low heat resistance and a poor moisture-proof property. A highly reliable flexible light-emitting device can be manufactured by transferring the protective film and the organic EL element to the organic resin substrate.

In the above methods for manufacturing the device, a crack (breaking or cracking the layer or the film) might occur in the insulating layer, the element layer, and films (typically an inorganic insulating film) of the functional layer at the time of peeling the formation substrate. Even when the crack that occurs in the device at the time of peeling is not fatal, the number of cracks or their sizes might be increased depending on subsequent manufacturing steps (e.g., heat treatment), the use of the device after manufacture, or the like. Furthermore, a crack might occur in the device or the number of cracks or their sizes might be increased when the device is bent or preserved in a high-temperature and high-humidity environment. The occurrence of a crack in the device results in a malfunction of the elements, a short lifetime, and the like and accordingly the reliability of the device might be reduced.

Here, the present inventors found that cracks in the insulating layer and the like occurs owing to the physical properties of the substrate, the bonding layer, and the insulating layer. Specifically, the physical properties are mainly a coefficient of linear expansion of the substrate, a glass transition temperature of the bonding layer, and stress of the insulating layer. These physical properties affect one another. For example, when the coefficient of linear expansion of the substrate is sufficiently small, acceptable ranges of the glass transition temperature of the bonding layer and the stress of the insulating layer become wider. When the glass transition temperature of the bonding layer is sufficiently high, acceptable ranges of the coefficient of linear expansion of the substrate and the stress of the insulating layer become wider. With an insulating layer having sufficiently high compressive stress, acceptable ranges of the coefficient of linear expansion of the substrate and the glass transition temperature of the bonding layer become wider.

The physical properties of the substrate, the bonding layer, and the insulating layer are described in detail below with reference to FIG. 1A1.

At least one of the insulating layers 105 and 115 has stress of a negative value (such stress corresponds to compressive stress). In particular, the stress is lower than 0 MPa, preferably lower than −15 MPa, further preferably lower than −100 MPa, and still further preferably lower than −150 MPa. The stress can be higher than or equal to −250 MPa and lower than 0 MPa, higher than or equal to −500 MPa and lower than 0 MPa, or higher than or equal to −1000 MPa and lower than 0 MPa. Note that the stress may be lower than or equal to −1000 MPa.

Occurrence of cracks in the insulating layer 105 and/or the insulating layer 115 in the case where the insulating layer 105 and/or the insulating layer 115 has compressive stress can be inhibited more than that in the case where the insulating layer 105 and the insulating layer 115 has tensile stress. As the compressive stress of the insulating layer 105 and the insulating layer 115 becomes higher, cracks are less likely to occur in the respective layers, which is preferable.

In the case where the insulating layer 105 and/or 115 is a stack of a plurality of layers, the stack may have compressive stress. That is, the stack may include a layer having tensile stress and a layer having compressive stress without limitation to the structure in which each layer included in the stack has compressive stress.

In some cases, the number of stacks in the functional layer 106b is smaller than that in the element layer 106a including a functional element, and the stress of the functional layer 106b is less likely to be controlled. A crack might occur in the device with a difference in stress between the element layer 106a and the functional layer 106b. Therefore, it is preferable that a value of the stress of the insulating layer 115 be negative (such stress corresponds to compressive stress) and that the absolute value be large.

At least one of the bonding layers 103 and 113 has a glass transition temperature higher than or equal to 60° C., preferably higher than or equal to 80° C. At least one of the bonding layers 103 and 113 has a coefficient of linear expansion preferably less than or equal to 100 ppm/K and further preferably less than or equal to 70 ppm/K.

At least one of the substrates 101 and 111 has a coefficient of linear expansion less than or equal to 60 ppm/K, preferably less than or equal to 30 ppm/K and further preferably less than or equal to 20 ppm/K. Furthermore, at least one of the substrates 101 and 111 has a glass transition temperature preferably higher than or equal to 150° C., further preferably higher than or equal to 200° C., and still further preferably higher than or equal to 250° C.

Occurrence of cracks in the insulating layer 105 and/or the insulating layer 115 can be inhibited as the glass transition temperature of the bonding layer or the substrate becomes higher and as the coefficient of linear expansion of the bonding layer or the substrate becomes smaller. Specifically, steps after attachment of the insulating layer and the substrate with the bonding layer, use of the device after manufacture, and the like inhibit occurrence of cracks in the insulating layers.

In particular, occurrence of cracks in the insulating layers can be inhibited by preserving the device in a high-temperature and high-humidity environment. Moisture is likely to be diffused particularly in the bonding layer and the substrate in a high-temperature and high-humidity environment. Force is applied to the insulating layer by expansion of the bonding layer and the substrate which is caused by permeation of moisture; thus, cracks might occur in the insulating layers. Occurrence of cracks in the insulating layers included in the light-emitting device of one embodiment of the present invention can be inhibited by any of a high grass transition temperature of the bonding layer or the substrate and a small coefficient of linear expansion of the bonding layer or the substrate.

When pressure-bonding of an FPC is performed, pressure application and heating are performed on at least one of the substrates 101 and 111. At this time, occurrence of cracks in the insulating layers can be inhibited as the glass transition temperature of the substrate becomes higher or as the substrate becomes thinner. For example, the thickness of the substrate is preferably greater than or equal to 1 μm and less than or equal to 200 μm, further preferably greater than or equal to 1 μm and less than or equal to 100 μm, still further preferably greater than or equal to 1 μm and less than or equal to 50 μm, and particularly preferably greater than or equal to 1 μm and less than or equal to 25 μm.

An insulating film having an excellent moisture-proof property is preferably used for the insulating layer 105 and/or the insulating layer 115. Alternatively, the insulating layer 105 and/or the insulating layer 115 preferably have a function of preventing diffusion of impurities to a light-emitting element.

As an insulating film having an excellent moisture-proof property, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the water vapor transmittance of the insulating film having an excellent moisture-proof property is lower than or equal to 1×10⁻⁵ [g/m²·day], preferably lower than or equal to 1×10⁻⁶ [g/m²·day], further preferably lower than or equal to 1×10−7 [g/m²·day], and still further preferably lower than or equal to 1×10⁻⁸ [g/m²·day].

In the light-emitting device, it is necessary that at least one of the insulating layers 105 and 115 transmit light emitted from the light-emitting element included in the element layer 106a or the element layer 106.

In the insulating layer that transmits light emitted from the light-emitting element, transmittance of light in a visible region is preferably 80% or more and further preferably 85% or more on the average. The transmittance of light having a wavelength of 475 nm in the insulating layer is preferably 70% or more, further preferably 80% or more, and still further preferably 85% or more. The transmittance of light having a wavelength of 650 nm in the insulating layer is preferably 70% or more, further preferably 80% or more, and still further preferably 85% or more.

The insulating layers 105 and 115 each preferably include oxygen, nitrogen, and silicon. The insulating layers 105 and 115 each preferably include, for example, silicon oxynitride. Moreover, the insulating layers 105 and 115 each preferably include silicon nitride or silicon nitride oxide. It is preferable that the insulating layers 105 and 115 be each formed using a silicon oxynitride film and a silicon nitride film, which are in contact with each other. The silicon oxynitride film and the silicon nitride film are alternately stacked so that antiphase interference occurs more often in a visible region, whereby the stack can have higher transmittance of light in the visible region.

Specific examples of a light-emitting device of one embodiment of the present invention are described below. The specific examples are each a light-emitting device including at least one of the substrate 101, the substrate 111, the bonding layer 103, the bonding layer 113, the insulating layer 105, and the insulating layer 115 which are described above. A light-emitting device in which cracks are less likely to occur can be achieved by satisfying any of the above physical properties in the preferable range described above.

### Specific Example 1

FIG. 1B is a plan view of the light-emitting device, and FIG. 1D is an example of a cross-sectional view taken along the dashed-dotted line A1-A2 in FIG. 1B. The light-emitting device in Specific Example 1 is a top-emission light-emitting device using a color filter method. In this embodiment, the light-emitting device can have a structure in which sub-pixels of three colors of, for example, red (R), green (G), and blue (B) express one color, a structure in which sub-pixels of four colors of R, G, B, and white (W) express one color, a structure in which sub-pixels of four colors of R, G, B, and yellow (Y) express one color, or the like. The color element is not particularly limited and colors other than R, G, B, W, and Y may be used. For example, cyan, magenta, or the like may be used.

The light-emitting device illustrated in FIG. 1B includes a light-emitting portion 804, a driver circuit portion 806, and an FPC 808.

The light-emitting device in FIG. 1D includes the substrate 101, the bonding layer 103, the insulating layer 105, a plurality of transistors, a conductive layer 857, an insulating layer 815, an insulating layer 817, a plurality of light-emitting elements, an insulating layer 821, a bonding layer 822, a coloring layer 845, a light-blocking layer 847, the insulating layer 115, the bonding layer 113, and the substrate 111. The bonding layer 822, the insulating layer 115, the bonding layer 113, and the substrate 111 transmit visible light. Light-emitting elements and transistors included in the light-emitting portion 804 and the driver circuit portion 806 are sealed with the substrate 101, the substrate 111, and the bonding layer 822.

The light-emitting portion 804 includes a transistor 820 and a light-emitting element 830 over the substrate 101 with the bonding layer 103 and the insulating layer 105 provided therebetween. The light-emitting element 830 includes a lower electrode 831 over the insulating layer 817, an EL layer 833 over the lower electrode 831, and an upper electrode 835 over the EL layer 833. The lower electrode 831 is electrically connected to a source electrode or a drain electrode of the transistor 820. An end portion of the lower electrode 831 is covered with the insulating layer 821. It is preferable that the lower electrode 831 reflect visible light. The upper electrode 835 transmits visible light.

In addition, the light-emitting portion 804 includes the coloring layer 845 overlapping with the light-emitting element 830 and the light-blocking layer 847 overlapping with the insulating layer 821. The space between the light-emitting element 830 and the coloring layer 845 is filled with the bonding layer 822.

The insulating layer 815 has an effect of inhibiting diffusion of impurities to a semiconductor included in the transistor. As the insulating layer 817, an insulating layer having a planarization function is preferably selected in order to reduce surface unevenness due to the transistor.

The driver circuit portion 806 includes a plurality of transistors over the substrate 101 with the bonding layer 103 and the insulating layer 105 provided therebetween. In FIG. 1D, one of the transistors included in the driver circuit portion 806 is illustrated.

The insulating layer 105 and the substrate 101 are attached to each other with the bonding layer 103. The insulating layer 115 and the substrate 111 are attached to each other with the bonding layer 113. It is preferable to use films having an excellent moisture-proof property as the insulating layer 105 and/or the insulating layer 115, in which case entry of an impurity such as moisture into the light-emitting element 830 or the transistor 820 can be inhibited, leading to improved reliability of the light-emitting device.

The conductive layer 857 is electrically connected to an external input terminal through which a signal (e.g., a video signal, a clock signal, a start signal, or a reset signal) or a potential from the outside is transmitted to the driver circuit portion 806. Here, an example in which the FPC 808 is provided as the external input terminal is described. To prevent an increase in the number of manufacturing steps, the conductive layer 857 is preferably formed using the same material and the same step(s) as those of the electrode or the wiring in the light-emitting portion or the driver circuit portion. Here, an example is described in which the conductive layer 857 is formed using the same material and the same step(s) as those of the electrodes of the transistor 820.

In the light-emitting device in FIG. 1D, the FPC 808 is positioned over the substrate 111. A connector 825 is connected to the conductive layer 857 through an opening provided in the substrate 111, the bonding layer 113, the insulating layer 115, the bonding layer 822, the insulating layer 817, and the insulating layer 815. Moreover, the connector 825 is connected to the FPC 808. The FPC 808 and the conductive layer 857 are electrically connected to each other with the connector 825 provided therebetween. In the case where the conductive layer 857 and the substrate 111 overlap with each other, the conductive layer 857, the connector 825, and the FPC 808 are electrically connected to one another by forming an opening in the substrate 111 (or using a substrate having an opening).

### Specific Example 2

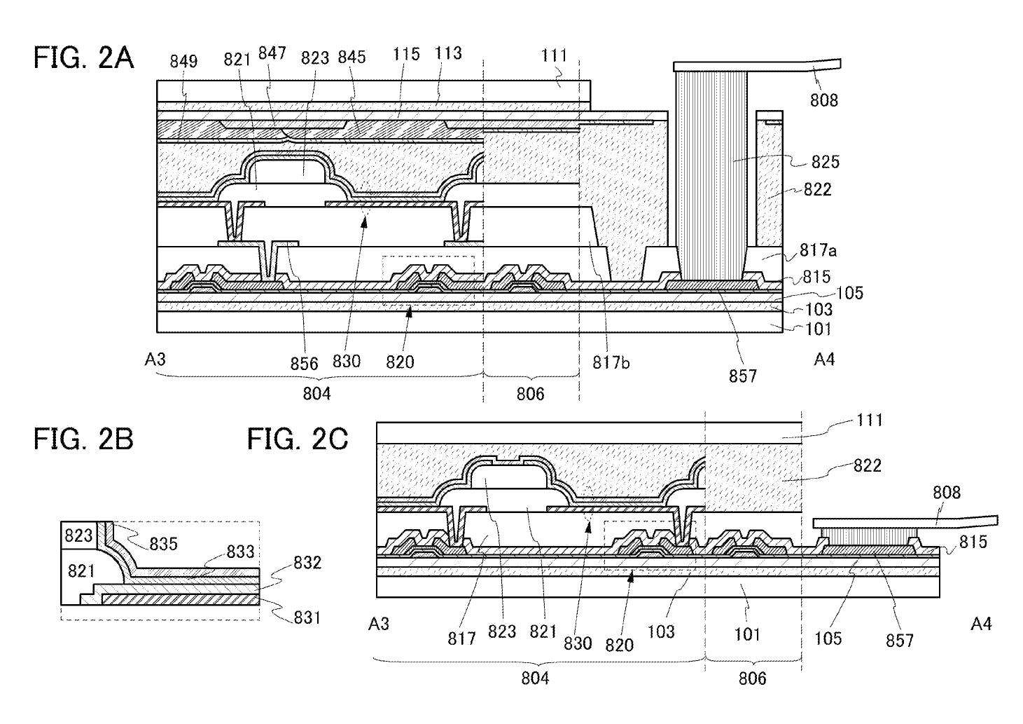

FIG. 1C is a plan view of the light-emitting device, and FIG. 2A is an example of a cross-sectional view taken along the dashed-dotted line A3-A4 in FIG. 1C. The light-emitting device in Specific Example 2 is a top-emission light-emitting device using a color filter method, which differs from the light-emitting device in Specific Example 1. Here, only different points from those of Specific Example 1 are described and the description of the same points as Specific Example 1 is omitted.

The light-emitting device illustrated in FIG. 2A differs from the light-emitting device in FIG. 1D in the following points.

The light-emitting device illustrated in FIG. 2A includes insulating layers 817a and 817b and a conductive layer 856 over the insulating layer 817a. The source electrode or the drain electrode of the transistor 820 and the lower electrode of the light-emitting element 830 are electrically connected to each other through the conductive layer 856.

The light-emitting device in FIG. 2A includes a spacer 823 over the insulating layer 821. The spacer 823 can adjust the distance between the substrate 101 and the substrate 111.

The light-emitting device in FIG. 2A includes an overcoat 849 covering the coloring layer 845 and the light-blocking layer 847. The space between the light-emitting element 830 and the overcoat 849 is filled with the bonding layer 822.

In addition, in the light-emitting device in FIG. 2A, the substrate 101 differs from the substrate 111 in size. The FPC 808 is positioned over the insulating layer 115 and does not overlap with the substrate 111. The connector 825 is connected to the conductive layer 857 through an opening provided in the insulating layer 115, the bonding layer 822, the insulating layer 817a, and the insulating layer 815. Since it is not necessary to form the opening in the substrate 111, the material of the substrate 111 is not limited.

Note that as illustrated in FIG. 2B, the light-emitting element 830 may include an optical adjustment layer 832 between the lower electrode 831 and the EL layer 833. It is preferable to use a conductive material having a light-transmitting property for the optical adjustment layer 832. Owing to the combination of a color filter (the coloring layer) and a microcavity structure (the optical adjustment layer), light with high color purity can be extracted from the light-emitting device of one embodiment of the present invention. The thickness of the optical adjustment layer may be varied depending on the color of the sub-pixel.

### Specific Example 3

FIG. 1C is a plan view of the light-emitting device, and FIG. 2C is an example of a cross-sectional view taken along the dashed-dotted line A3-A4 in FIG. 1C. The light-emitting device in Specific Example 3 is a top-emission light-emitting device using a separate coloring method.

The light-emitting device in FIG. 2C includes the substrate 101, the bonding layer 103, the insulating layer 105, a plurality of transistors, the conductive layer 857, the insulating layer 815, the insulating layer 817, a plurality of light-emitting elements, the insulating layer 821, the spacer 823, the bonding layer 822, and the substrate 111. The bonding layer 822 and the substrate 111 transmit visible light.

In the light-emitting device in FIG. 2C, the connector 825 is positioned over the insulating layer 815. The connector 825 is connected to the conductive layer 857 through an opening provided in the insulating layer 815. Moreover, the connector 825 is connected to the FPC 808. The FPC 808 and the conductive layer 857 are electrically connected to each other with the connector 825 provided therebetween.

### Specific Example 4

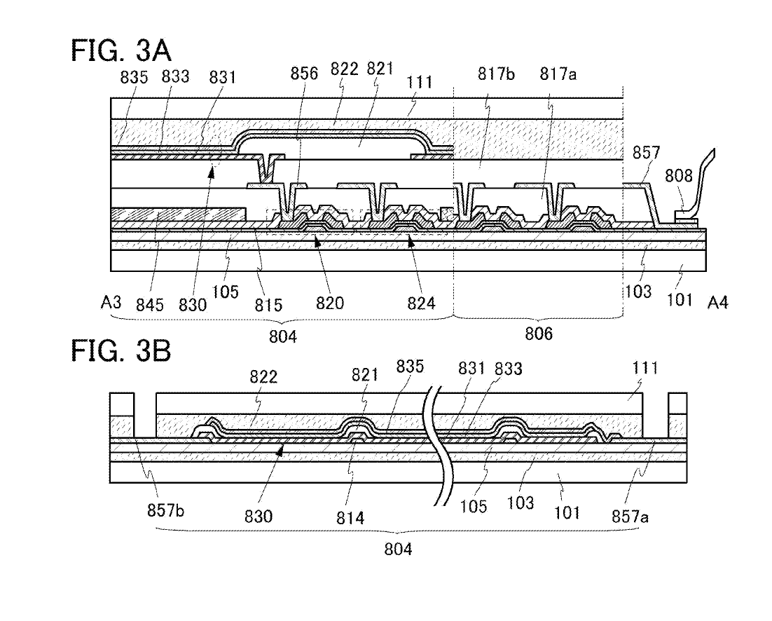

FIG. 1C is a plan view of the light-emitting device, and FIG. 3A is an example of a cross-sectional view taken along the dashed-dotted line A3-A4 in FIG. 1C. The light-emitting device in Specific Example 4 is a bottom-emission light-emitting device using a color filter method.

The light-emitting device in FIG. 3A includes the substrate 101, the bonding layer 103, the insulating layer 105, a plurality of transistors, the conductive layer 857, the insulating layer 815, the coloring layer 845, the insulating layer 817a, the insulating layer 817b, the conductive layer 856, a plurality of light-emitting elements, the insulating layer 821, the bonding layer 822, and the substrate 111. The substrate 101, the bonding layer 103, the insulating layer 105, the insulating layer 815, the insulating layer 817a, and the insulating layer 817b transmit visible light.

The light-emitting portion 804 includes the transistor 820, a transistor 824, and the light-emitting element 830 over the substrate 101 with the bonding layer 103 and the insulating layer 105 provided therebetween. The light-emitting element 830 includes the lower electrode 831 over the insulating layer 817b, the EL layer 833 over the lower electrode 831, and the upper electrode 835 over the EL layer 833. The lower electrode 831 is electrically connected to the source electrode or the drain electrode of the transistor 820. An end portion of the lower electrode 831 is covered with the insulating layer 821. It is preferable that the upper electrode 835 reflect visible light. The lower electrode 831 transmits visible light. The location of the coloring layer 845 overlapping with the light-emitting element 830 is not particularly limited and may be, for example, between the insulating layer 817a and the insulating layer 817b or between the insulating layer 815 and the insulating layer 817a.

The driver circuit portion 806 includes a plurality of transistors over the substrate 101 with the bonding layer 103 and the insulating layer 105 provided therebetween. In FIG. 3A, two of the transistors included in the driver circuit portion 806 is illustrated.

The insulating layer 105 and the substrate 101 are attached to each other with the bonding layer 103. It is preferable to use films having an excellent moisture-proof property as the insulating layer 105, in which case entry of an impurity such as moisture into the light-emitting element 830 or the transistors 820 and 824 can be inhibited, leading to improved reliability of the light-emitting device.

The conductive layer 857 is electrically connected to an external input terminal through which a signal or a potential from the outside is transmitted to the driver circuit portion 806. Here, an example in which the FPC 808 is provided as the external input terminal is described. Here, an example is described in which the conductive layer 857 is formed using the same material and the same step(s) as those of the conductive layer 856.

### Specific Example 5

FIG. 3B shows an example of a light-emitting device different from those of Specific Examples 1 to 4.

A light-emitting device in FIG. 3B includes the substrate 101, the bonding layer 103, the insulating layer 105, a conductive layer 814, a conductive layer 857a, a conductive layer 857b, the light-emitting element 830, the insulating layer 821, the bonding layer 822, and the substrate 111.

The conductive layer 857a and the conductive layer 857b, which are external connection electrodes of the light-emitting device, can each be electrically connected to an FPC or the like.

The light-emitting element 830 includes the lower electrode 831, the EL layer 833, and the upper electrode 835. The end portion of the lower electrode 831 is covered with the insulating layer 821. The light-emitting element 830 has a bottom emission structure, a top emission structure, or a dual emission structure. The electrode, the substrate, the insulating layer, and the like through each of which light is extracted transmit visible light. The conductive layer 814 is electrically connected to the lower electrode 831.

The substrate through which light is extracted may have, as a light extraction structure, a hemispherical lens, a micro lens array, a film provided with an uneven surface structure, a light diffusing film, or the like. For example, a substrate having the light extraction structure can be formed by bonding the above lens or film to a resin substrate with an adhesive or the like having substantially the same refractive index as the substrate or the lens or film.

The conductive layer 814 is preferably, though not necessarily, provided because voltage drop due to the resistance of the lower electrode 831 can be inhibited. In addition, for a similar purpose, a conductive layer electrically connected to the upper electrode 835 may be provided over the insulating layer 821, the EL layer 833, the upper electrode 835, or the like.

The conductive layer 814 can be formed to have a single-layer structure or a stacked-layer structure using a material selected from copper, titanium, tantalum, tungsten, molybdenum, chromium, neodymium, scandium, nickel, or aluminum, an alloy material containing any of these materials as its main component, and the like. The thickness of the conductive layer 814 can be greater than or equal to 0.1 μm and less than or equal to 3 μm, preferably greater than or equal to 0.1 μm and less than or equal to 0.5 μm, for example.

### Examples of Materials

Next, materials and the like that can be used for a light-emitting device are described. Note that description on the components already described in this specification and the like is omitted in some cases.

As materials for the substrates, glass, quartz, an organic resin, metal, an alloy, or the like can be used. The substrate through which light from the light-emitting element is extracted is formed using a material which transmits the light.

In particular, a flexible substrate is preferably used. For example, an organic resin; or glass, a metal, or an alloy that is thin enough to have flexibility can be used.

An organic resin, which has a specific gravity smaller than that of glass, is preferably used for the flexible substrate, in which case the light-emitting device can be lightweight as compared with the case where glass is used.

The substrate is preferably formed using a material with high toughness. In that case, a light-emitting device with high impact resistance that is less likely to be broken can be provided. For example, when an organic resin substrate or a thin metal or alloy substrate is used, the light-emitting device can be lightweight and unlikely to be broken as compared with the case where a glass substrate is used.

A metal material and an alloy material, which have high thermal conductivity, are preferable because they can easily conduct heat to the whole substrate and accordingly can prevent a local temperature rise in the light-emitting device. The thickness of a substrate using a metal material or an alloy material is preferably greater than or equal to 10 μm and less than or equal to 200 μm and further preferably greater than or equal to 20 μm and less than or equal to 50 μm.

There is no particular limitation on a material of the metal substrate or the alloy substrate, but it is preferable to use, for example, aluminum, copper, nickel, a metal alloy such as an aluminum alloy or stainless steel.

Furthermore, when a material with high thermal emissivity is used for the substrate, the surface temperature of the light-emitting device can be prevented from rising, leading to inhibition of breakage or a decrease in reliability of the light-emitting device. For example, the substrate may have a stacked-layer structure of a metal substrate and a layer with high thermal emissivity (the layer can be formed using a metal oxide or a ceramic material, for example).

Examples of such a material having flexibility and a light-transmitting property include polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin (e.g., nylon or aramid), a cycloolefin resin, a polystyrene resin, a polyamide imide resin, and a polyvinyl chloride resin. In particular, a material having a low coefficient of thermal expansion is preferable, and for example, a polyamide imide resin, a polyimide resin, or PET can be suitably used. A substrate in which a fibrous body is impregnated with a resin (also referred to as prepreg) or a substrate whose coefficient of thermal expansion is reduced by mixing an organic resin with an inorganic filler can also be used.

The flexible substrate may have a stacked-layer structure in which a hard coat layer (e.g., a silicon nitride layer) by which a surface of the light-emitting device is protected from damage, a layer which can disperse pressure (e.g., an aramid resin layer), or the like is stacked over a layer of any of the above-mentioned materials.

The flexible substrate may be formed by stacking a plurality of layers. When a glass layer is used, a barrier property against water and oxygen can be improved and thus a highly reliable light-emitting device can be provided.

For example, a flexible substrate in which a glass layer, a bonding layer, and an organic resin layer are stacked from the side closer to a light-emitting element can be used. The thickness of the glass layer is greater than or equal to 20 μm and less than or equal to 200 μm, preferably greater than or equal to 25 μm and less than or equal to 100 μm. With such a thickness, the glass layer can have both a high barrier property against water and oxygen and high flexibility. The thickness of the organic resin layer is greater than or equal to 10 μm and less than or equal to 200 μm, preferably greater than or equal to 20 μm and less than or equal to 50 μm. By providing such an organic resin layer outside the glass layer, occurrence of a crack or a break in the glass layer can be inhibited and mechanical strength can be improved. With the substrate that includes such a composite material of a glass material and an organic resin, a highly reliable flexible light-emitting device can be provided.

As the bonding layer, a variety of curable adhesives such as a reactive curable adhesive, a thermosetting adhesive, an anaerobic adhesive, and a photo curable adhesive such as an ultraviolet curable adhesive can be used. Examples of such adhesives include an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, and the like. In particular, a material with low moisture permeability, such as an epoxy resin, is preferable. Alternatively, a two-component-mixture-type resin may be used. Further alternatively, a bonding sheet or the like may be used.

Furthermore, the resin may include a drying agent. For example, a substance which adsorbs moisture by chemical adsorption, such as an oxide of an alkaline earth metal (e.g., calcium oxide or barium oxide), can be used. Alternatively, a substance that adsorbs moisture by physical adsorption, such as zeolite or silica gel, may be used. The drying agent is preferably included, in which case entry of impurities such as moisture into the functional element can be inhibited and the reliability of the light-emitting device can be improved.

In addition, a filler with a high refractive index or a light scattering member is mixed into the resin, in which case the efficiency of light extraction from the light-emitting element can be improved. For example, titanium oxide, barium oxide, zeolite, zirconium, or the like can be used.

There is no particular limitation on the structure of the transistor in the light-emitting device. For example, a forward staggered transistor or an inverted staggered transistor may be used. Furthermore, a top-gate transistor or a bottom-gate transistor may be used. A semiconductor material used for the transistors is not particularly limited, and for example, silicon, germanium, or an organic semiconductor can be used. Alternatively, an oxide semiconductor containing at least one of indium, gallium, and zinc, such as an In—Ga—Zn-based metal oxide, may be used.

There is no particular limitation on the crystallinity of a semiconductor material used for the transistors, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be inhibited.

For stable characteristics of the transistor, a base film is preferably provided. The base film can be formed to have a single-layer structure or a stacked-layer structure using an inorganic insulating film such as a silicon oxide film, a silicon nitride film, a silicon oxynitride film, or a silicon nitride oxide film. The base film can be formed by a sputtering method, a chemical vapor deposition (CVD) method (e.g., a plasma CVD method, a thermal CVD method, or a metal organic CVD (MOCVD) method), an atomic layer deposition (ALD) method, a coating method, a printing method, or the like. Note that the base film is not necessarily provided. In each of the above structure examples, the insulating layer 105 can serve as a base film of the transistor.

As the light-emitting element, a self-luminous element can be used, and an element whose luminance is controlled by current or voltage is included in the category of the light-emitting element. For example, a light-emitting diode (LED), an organic EL element, an inorganic EL element, or the like can be used.

The light-emitting element may have any of a top emission structure, a bottom emission structure, and a dual emission structure. A conductive film that transmits visible light is used as the electrode through which light is extracted. A conductive film that reflects visible light is preferably used as the electrode through which light is not extracted.

The conductive film that transmits visible light can be formed using, for example, indium oxide, indium tin oxide (ITO), indium zinc oxide, zinc oxide, or zinc oxide to which gallium is added. Alternatively, a film of a metal material such as gold, silver, platinum, magnesium, nickel, tungsten, chromium, molybdenum, iron, cobalt, copper, palladium, or titanium; an alloy containing any of these metal materials; a nitride of any of these metal materials (e.g., titanium nitride); or the like can be formed thin so as to have a light-transmitting property. Alternatively, a stacked film of any of the above materials can be used as the conductive film. For example, a stacked film of ITO and an alloy of silver and magnesium is preferably used, in which case conductivity can be increased. Further alternatively, graphene or the like may be used.

For the conductive film that reflects visible light, for example, a metal material such as aluminum, gold, platinum, silver, nickel, tungsten, chromium, molybdenum, iron, cobalt, copper, or palladium or an alloy containing any of these metal materials can be used. In addition, lanthanum, neodymium, germanium, or the like may be added to the metal material or the alloy. Moreover, an alloy containing aluminum (an aluminum alloy) such as an alloy of aluminum and titanium, an alloy of aluminum and nickel, or an alloy of aluminum and neodymium; or an alloy containing silver such as an alloy of silver and copper, an alloy of silver, copper, and palladium, or an alloy of silver and magnesium can be used for the conductive film. An alloy of silver and copper is preferable because of its high heat resistance. Furthermore, when a metal film or a metal oxide film is stacked on and in contact with an aluminum alloy film, oxidation of the aluminum alloy film can be inhibited. Examples of materials for the metal film or the metal oxide film include titanium and titanium oxide. Alternatively, the above conductive film that transmits visible light and a film containing a metal material may be stacked. For example, a stacked film of silver and ITO or a stacked film of an alloy of silver and magnesium and ITO can be used.

Each of the electrodes can be formed by an evaporation method or a sputtering method. Alternatively, a discharging method such as an inkjet method, a printing method such as a screen printing method, or a plating method may be used.

When a voltage higher than the threshold voltage of the light-emitting element is applied between the lower electrode 831 and the upper electrode 835, holes are injected to the EL layer 833 from the anode side and electrons are injected to the EL layer 833 from the cathode side. The injected electrons and holes are recombined in the EL layer 833 and a light-emitting substance contained in the EL layer 833 emits light.

The EL layer 833 includes at least a light-emitting layer. In addition to the light-emitting layer, the EL layer 833 may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

For the EL layer 833, either a low molecular compound or a high molecular compound can be used, and an inorganic compound may also be used. Each of the layers included in the EL layer 833 can be formed by any of the following methods: an evaporation method (including a vacuum evaporation method), a transfer method, a printing method, an inkjet method, a coating method, and the like.

The light-emitting element 830 may contain two or more kinds of light-emitting substances. Thus, for example, a light-emitting element that emits white light can be achieved. For example, a white emission can be obtained by selecting light-emitting substances so that two or more kinds of light-emitting substances emit light of complementary colors. A light-emitting substance that emits red (R) light, green (G) light, blue (B) light, yellow (Y) light, or orange (O) light or a light-emitting substance that emits light containing spectral components of two or more of R light, G light, and B light can be used, for example. A light-emitting substance that emits blue light and a light-emitting substance that emits yellow light may be used, for example. At this time, the emission spectrum of the light-emitting substance that emits yellow light preferably contains spectral components of G light and R light. The emission spectrum of the light-emitting element 830 preferably has two or more peaks in the range of a wavelength (e.g., from 350 nm to 750 nm) in a visible region.

The EL layer 833 may include a plurality of light-emitting layers. In the EL layer 833, the plurality of light-emitting layers may be stacked in contact with one another or may be stacked with a separation layer provided therebetween. The separation layer may be provided between a fluorescent layer and a phosphorescent layer, for example.

The separation layer can be provided, for example, to prevent energy transfer by the Dexter mechanism (particularly triplet energy transfer) from a phosphorescent material or the like in an excited state which is generated in the phosphorescent layer to a fluorescent material or the like in the fluorescent layer. The thickness of the separation layer may be several nanometers. Specifically, the thickness of the separation layer may be greater than or equal to 0.1 nm and less than or equal to 20 nm, greater than or equal to 1 nm and less than or equal to 10 nm, or greater than or equal to 1 nm and less than or equal to 5 nm. The separation layer contains a single material (preferably, a bipolar substance) or a plurality of materials (preferably, a hole-transport material and an electron-transport material).

The separation layer may be formed using a material contained in a light-emitting layer in contact with the separation layer. This facilitates the manufacture of the light-emitting element and reduces the drive voltage. For example, in the case where the phosphorescent layer includes a host material, an assist material, and a phosphorescent material (guest material), the separation layer may be formed using the host material and the assist material. In other words, the separation layer includes a region not containing the phosphorescent material and the phosphorescent layer includes a region containing the phosphorescent material in the above structure. Accordingly, the separation layer and the phosphorescent layer can be evaporated separately depending on whether a phosphorescent material is used or not. With such a structure, the separation layer and the phosphorescent layer can be formed in the same chamber. Thus, the manufacturing costs can be reduced.

Moreover, the light-emitting element 830 may be a single element including one EL layer or a tandem element in which EL layers are stacked with a charge generation layer provided therebetween.

The light-emitting element is preferably provided between a pair of insulating films having an excellent moisture-proof property. In that case, entry of an impurity such as moisture into the light-emitting element can be inhibited, leading to inhibition of a decrease in the reliability of the light-emitting device.

As the insulating layer 815, for example, an inorganic insulating film such as a silicon oxide film, a silicon oxynitride film, or an aluminum oxide film can be used. For example, as the insulating layer 817, the insulating layer 817a, and the insulating layer 817b, an organic material such as polyimide, acrylic, polyamide, polyimide amide, or a benzocyclobutene-based resin can be used. Alternatively, a low-dielectric constant material (a low-k material) or the like can be used. Furthermore, each insulating layer may be formed by stacking a plurality of insulating films.

For the insulating layer 821, an organic insulating material or an inorganic insulating material is used. As the resin, for example, a polyimide resin, a polyamide resin, an acrylic resin, a siloxane resin, an epoxy resin, or a phenol resin can be used. It is particularly preferable that the insulating layer 821 be formed to have an inclined side wall with curvature, using a photosensitive resin material.

There is no particular limitation on the method for forming the insulating layer 821; a photolithography method, a sputtering method, an evaporation method, a droplet discharging method (e.g., an inkjet method), a printing method (e.g., a screen printing method or an off-set printing method), or the like may be used.

The spacer 823 can be formed using an inorganic insulating material, an organic insulating material, a metal material, or the like. As the inorganic insulating material and the organic insulating material, for example, a variety of materials that can be used for the insulating layer can be used. As the metal material, titanium, aluminum, or the like can be used. When the spacer 823 containing a conductive material is electrically connected to the upper electrode 835, a potential drop due to the resistance of the upper electrode 835 can be inhibited. The spacer 823 may have either a tapered shape or an inverse tapered shape.

For example, a conductive layer functioning as an electrode or a wiring of the transistor, an auxiliary electrode of the light-emitting element, or the like, which is used for the light-emitting device, can be formed to have a single-layer structure or a stacked-layer structure using any of metal materials such as molybdenum, titanium, chromium, tantalum, tungsten, aluminum, copper, neodymium, and scandium, and an alloy material containing any of these elements. Alternatively, the conductive layer may be formed using a conductive metal oxide. As the conductive metal oxide, indium oxide (e.g., In₂O₃), tin oxide (e.g., SnO₂), zinc oxide (ZnO), ITO, indium zinc oxide (e.g., In₂O₃—ZnO), or any of these metal oxide materials in which silicon oxide is contained can be used.

The coloring layer is a colored layer that transmits light in a specific wavelength range. For example, a red (R) color filter for transmitting light in a red wavelength range, a green (G) color filter for transmitting light in a green wavelength range, a blue (B) color filter for transmitting light in a blue wavelength range, a yellow (Y) color filter for transmitting light in a yellow wavelength range, or the like can be used. Each coloring layer is formed in a desired position with any of a variety of materials by a printing method, an inkjet method, an etching method using a photolithography method, or the like. In a white sub-pixel, a resin such as a transparent resin or a white resin may be provided so as to overlap with the light-emitting element.

The light-blocking layer is provided between the adjacent coloring layers. The light-blocking layer blocks light emitted from an adjacent light-emitting element to inhibit color mixture between adjacent light-emitting elements. Here, the coloring layer is provided such that its end portion overlaps with the light-blocking layer, whereby light leakage can be reduced. As the light-blocking layer, a material that can block light from the light-emitting element can be used; for example, a black matrix is formed using a resin material containing a metal material, pigment, or dye. Note that it is preferable to provide the light-blocking layer in a region other than the light-emitting portion, such as a driver circuit portion, in which case undesired leakage of guided light or the like can be inhibited.

Furthermore, an overcoat covering the coloring layer and the light-blocking layer may be provided. The overcoat can prevent an impurity and the like contained in the coloring layer from being diffused into the light-emitting element. The overcoat is formed with a material that transmits light emitted from the light-emitting element; for example, an inorganic insulating film such as a silicon nitride film or a silicon oxide film, an organic insulating film such as an acrylic film or a polyimide film can be used, and further, a stacked-layer structure of an organic insulating film and an inorganic insulating film may be employed.

In the case where upper surfaces of the coloring layer and the light-blocking layer are coated with a material of the bonding layer, a material which has high wettability with respect to the material of the bonding layer is preferably used as the material of the overcoat. For example, an oxide conductive film such as an ITO film or a metal film such as an Ag film which is thin enough to transmit light is preferably used as the overcoat.

As the connector, any of a variety of anisotropic conductive films (ACF), anisotropic conductive pastes (ACP), and the like can be used.

Note that although the light-emitting device is described as an example in this embodiment, one embodiment of the present invention can be applied to a variety of devices such as a semiconductor device, a display device, and an input/output device.

In this specification and the like, a display element, a display device which is a device including a display element, a light-emitting element, and a light-emitting device which is a device including a light-emitting element can employ various modes or can include various elements. A display element, a display device, a light-emitting element, or a light-emitting device includes, for example, at least one of an EL element (e.g., an EL element including organic and inorganic materials, an organic EL element, or an inorganic EL element), an LED (e.g., a white LED, a red LED, a green LED, or a blue LED), a transistor (a transistor which emits light depending on current), an electron emitter, a liquid crystal element, electronic ink, an electrophoretic element, a grating light valve (GLV), a plasma display panel (PDP), a display element including a micro electro mechanical system (MEMS), a digital micromirror device (DMD), a digital micro shutter (DMS), an interferometric modulator display (IMOD) element, an MEMS shutter display element, optical interference type MEMS display element, an electrowetting element, a piezoelectric ceramic display, and a display element including a carbon nanotube. Other than the above, display media whose contrast, luminance, reflectivity, transmittance, or the like is changed by electrical or magnetic effect may be included. Note that examples of a display device having an EL element include an EL display. Examples of a display device having an electron emitter include a field emission display (FED) and an SED-type flat panel display (SED: surface-conduction electron-emitter display). Examples of a display device having a liquid crystal element include a liquid crystal display (e.g., a transmissive liquid crystal display, a transflective liquid crystal display, a reflective liquid crystal display, a direct-view liquid crystal display, or a projection liquid crystal display). Examples of a display device having electronic ink, ELECTRONIC LIQUID POWDER (registered trademark), or an electrophoretic element include electronic paper. In the case of a transflective liquid crystal display or a reflective liquid crystal display, some of or all of pixel electrodes function as reflective electrodes. For example, some or all of pixel electrodes are formed to contain aluminum or silver. Furthermore, in such a case, a memory circuit such as an SRAM can be provided under the reflective electrodes, leading to lower power consumption.

For example, in this specification and the like, an active matrix method in which an active element (a non-linear element) is included in a pixel or a passive matrix method in which an active element is not included in a pixel can be used.

In the active matrix method, as an active element, not only a transistor but also a variety of active elements can be used. For example, a metal insulator metal (MIM), a thin film diode (TFD), or the like can also be used. Since these elements can be formed with a smaller number of manufacturing steps, manufacturing cost can be reduced or a yield can be improved. Alternatively, since the size of these elements is small, the aperture ratio can be improved, so that power consumption can be reduced or higher luminance can be achieved.

Since an active element is not used in the passive matrix method, the number of manufacturing steps is small, so that manufacturing cost can be reduced or a yield can be improved. Alternatively, since an active element is not used, the aperture ratio can be improved, so that power consumption can be reduced or higher luminance can be achieved, for example.

Note that the light-emitting device of one embodiment of the present invention may be used as a display device or as a lighting device. For example, it may be used as a light source such as a backlight or a front light, that is, a lighting device for a display panel.

As described above in this embodiment, since the device of one embodiment of the present invention includes the insulating layer having compressive stress, the bonding layer having a glass transition temperature higher than or equal to 60° C., the substrate having a coefficient of linear expansion less than or equal to 60 ppm/K, and the like, occurrence of cracks in the insulating layers and the element can be inhibited. Moreover, even when cracks occur in the insulating layers and the element, development of the cracks can be inhibited. Accordingly, a device having high reliability and high resistance to repeated bending can be achieved.

This embodiment can be combined with any other embodiment as appropriate.

### Embodiment 2

In this embodiment, an input/output device of one embodiment of the present invention will be described with reference to drawings. Note that the above description can be referred to for the components of an input/output device, which are similar to those of the light-emitting device described in Embodiment 1. Although an input/output device including a light-emitting element is described as an example in this embodiment, one embodiment of the present invention is not limited thereto. For example, an input/output device including another element (e.g., a display element), the example of which is shown in Embodiment 1, is also one embodiment of the present invention. Moreover, the input/output device described in this embodiment can also be referred to as a touch panel.

As described above in this embodiment, since the input/output device of one embodiment of the present invention includes the insulating layer having compressive stress, the bonding layer having a glass transition temperature higher than or equal to 60° C., the substrate having a coefficient of linear expansion less than or equal to 60 ppm/K, and the like, occurrence of cracks in the insulating layers and the element can be inhibited. Moreover, even when cracks occur in the insulating layers and the element, development of the cracks can be inhibited. Accordingly, an input/output device having high reliability and high resistance to repeated bending can be achieved.

### Structure Example 1

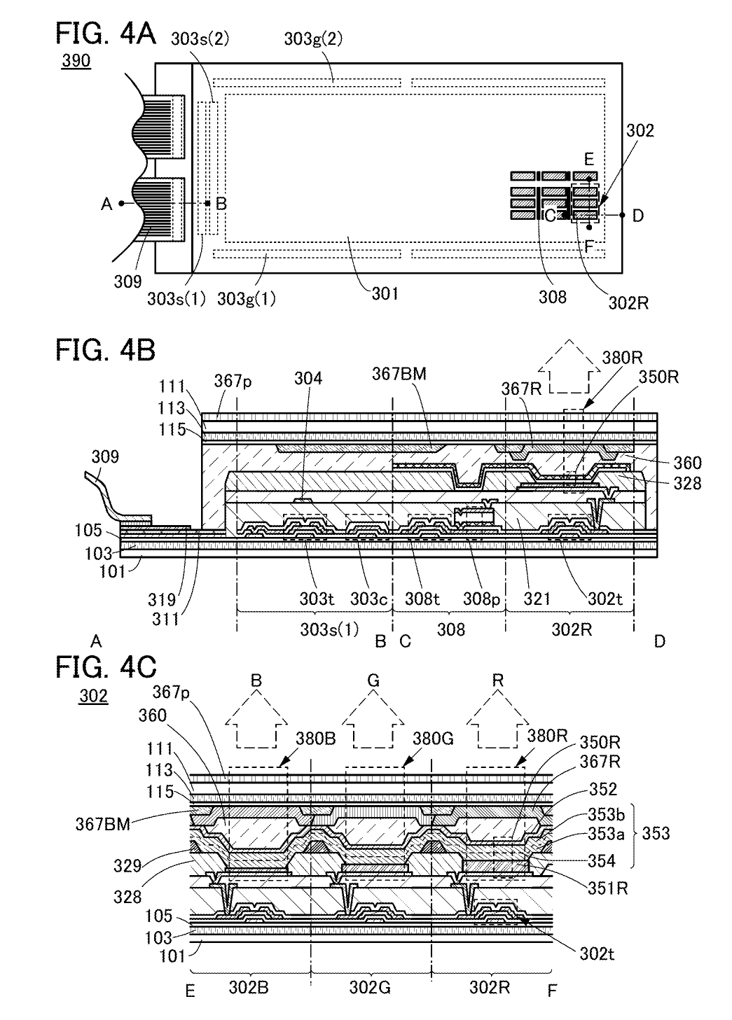

FIG. 4A is a top view of the input/output device. FIG. 4B is a cross-sectional view taken along the dashed-dotted line A-B and dashed-dotted line C-D in FIG. 4A. FIG. 4C is a cross-sectional view taken along the dashed-dotted line E-F in FIG. 4A.

An input/output device 390 illustrated in FIG. 4A includes a display portion 301 (serving also as an input portion), a scan line driver circuit 303g(1), an imaging pixel driver circuit 303g(2), an image signal line driver circuit 303s(1), and an imaging signal line driver circuit 303s(2).

The display portion 301 includes a plurality of pixels 302 and a plurality of imaging pixels 308.

The pixel 302 includes a plurality of sub-pixels (e.g., a sub-pixel 302R). Each sub-pixel includes a light-emitting element and a pixel circuit.

The pixel circuits can supply electric power for driving the light-emitting element. The pixel circuits are electrically connected to wirings through which selection signals are supplied. The pixel circuits are also electrically connected to wirings through which image signals are supplied.

The scan line driver circuit 303g(1) can supply selection signals to the pixels 302.

The image signal line driver circuit 303s(1) can supply image signals to the pixels 302.

A touch sensor can be formed using the imaging pixels 308. Specifically, the imaging pixels 308 can sense a touch of a finger or the like on the display portion 301.

The imaging pixels 308 include photoelectric conversion elements and imaging pixel circuits.

The imaging pixel circuits can drive photoelectric conversion elements. The imaging pixel circuits are electrically connected to wirings through which control signals are supplied. The imaging pixel circuits are also electrically connected to wirings through which power supply potentials are supplied.

Examples of the control signal include a signal for selecting an imaging pixel circuit from which a recorded imaging signal is read, a signal for initializing an imaging pixel circuit, and a signal for determining the time it takes for an imaging pixel circuit to sense light.

The imaging pixel driver circuit 303g(2) can supply control signals to the imaging pixels 308.

The imaging signal line driver circuit 303s(2) can read out imaging signals.

As illustrated in FIGS. 4B and 4C, the input/output device 390 includes the substrate 101, the bonding layer 103, the insulating layer 105, the substrate 111, the bonding layer 113, and the insulating layer 115. The substrates 101 and 111 are attached to each other with a bonding layer 360.

The substrate 101 and the insulating layer 105 are attached to each other with the bonding layer 103. The substrate 111 and the insulating layer 115 are attached to each other with the bonding layer 113. Embodiment 1 can be referred to for materials used for the substrates, the bonding layers, and the insulating layers.

Each of the pixels 302 includes the sub-pixel 302R, a sub-pixel 3020 and a sub-pixel 302B (see FIG. 4C). The sub-pixel 302R includes a light-emitting module 380R, the sub-pixel 302G includes a light-emitting module 380G, and the sub-pixel 302B includes a light-emitting module 380B.

For example, the sub-pixel 302R includes the light-emitting element 350R and the pixel circuit. The pixel circuit includes a transistor 302t that can supply electric power to the light-emitting element 350R. Furthermore, the light-emitting module 380R includes the light-emitting element 350R and an optical element (e.g., a coloring layer 367R that transmits red light).

The light-emitting element 350R includes a lower electrode 351R, an EL layer 353, and an upper electrode 352, which are stacked in this order (see FIG. 4C).

The EL layer 353 includes a first EL layer 353a, an intermediate layer 354, and a second EL layer 353b, which are stacked in this order.

Note that a microcavity structure can be provided for the light-emitting module 380R so that light with a specific wavelength can be efficiently extracted. Specifically, an EL layer may be provided between a film that reflects visible light and a film that partly reflects and partly transmits visible light, which are provided so that light with a specific wavelength can be efficiently extracted.

The light-emitting module 380R, for example, includes the bonding layer 360 that is in contact with the light-emitting element 350R and the coloring layer 367R.

The coloring layer 367R is positioned in a region overlapping with the light-emitting element 350R. Accordingly, part of light emitted from the light-emitting element 350R passes through the bonding layer 360 and through the coloring layer 367R and is emitted to the outside of the light-emitting module 380R as indicated by an arrow in FIG. 4B or 4C.

The input/output device 390 includes a light-blocking layer 367BM. The light-blocking layer 367BM is provided so as to surround the coloring layer (e.g., the coloring layer 367R).

The input/output device 390 includes an anti-reflective layer 367p positioned in a region overlapping with the display portion 301. As the anti-reflective layer 367p, a circular polarizing plate can be used, for example.

The input/output device 390 includes an insulating layer 321. The insulating layer 321 covers the transistor 302t and the like. Note that the insulating layer 321 can be used as a layer for planarizing unevenness caused by the pixel circuits and the imaging pixel circuits. An insulating layer on which a layer that can inhibit diffusion of impurities to the transistor 302t and the like is stacked can be used as the insulating layer 321.

The input/output device 390 includes a partition 328 that overlaps with an end portion of the lower electrode 351R. In addition, a spacer 329 that controls the distance between the substrate 101 and the substrate 111 is provided on the partition 328.

The image signal line driver circuit 303s(1) includes a transistor 303t and a capacitor 303c. Note that the driver circuit can be formed in the same process and over the same substrate as those of the pixel circuits. As illustrated in FIG. 4B, the transistor 303t may include a second gate 304 over the insulating layer 321. The second gate 304 may be electrically connected to a gate of the transistor 303t, or different potentials may be supplied to these gates. Alternatively, if necessary, the second gate 304 may be provided for a transistor 308t, the transistor 302t, or the like.

The imaging pixels 308 each include a photoelectric conversion element 308p and an imaging pixel circuit. The imaging pixel circuit can sense light received by the photoelectric conversion element 308p. The imaging pixel circuit includes the transistor 308t.

For example, a PIN photodiode can be used as the photoelectric conversion element 308p.

The input/output device 390 includes a wiring 311 through which a signal is supplied. The wiring 311 is provided with a terminal 319. Note that an FPC 309 through which a signal such as an image signal or a synchronization signal is supplied is electrically connected to the terminal 319. Note that a printed wiring board (PWB) may be attached to the FPC 309.

Note that transistors such as the transistors 302t, 303t, and 308t can be formed in the same process. Alternatively, the transistors may be formed in different processes.

### Structure Example 2

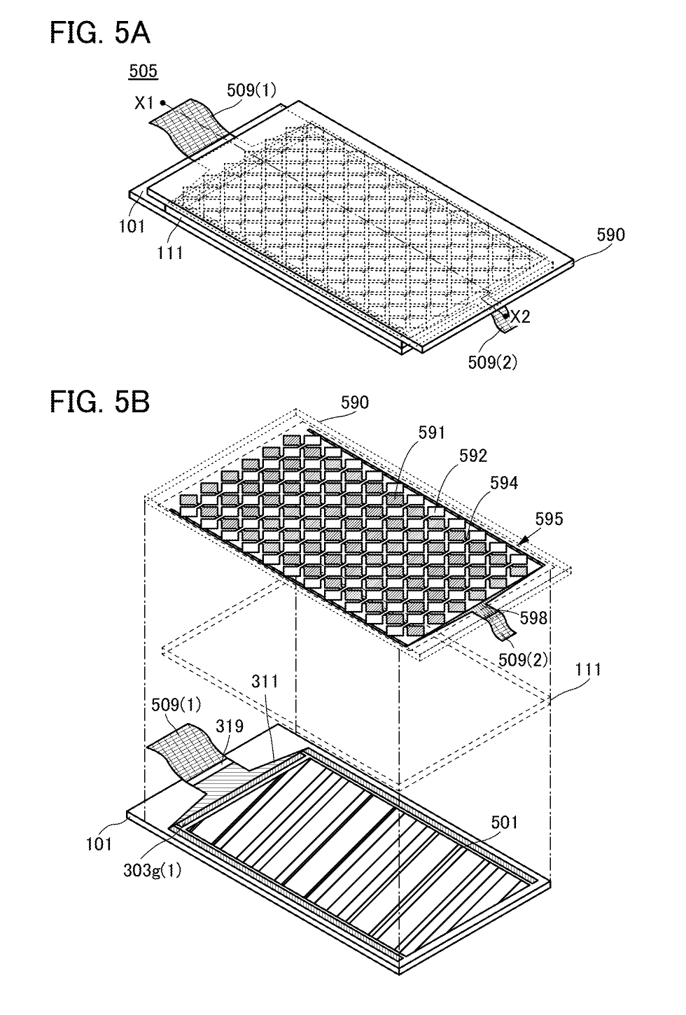

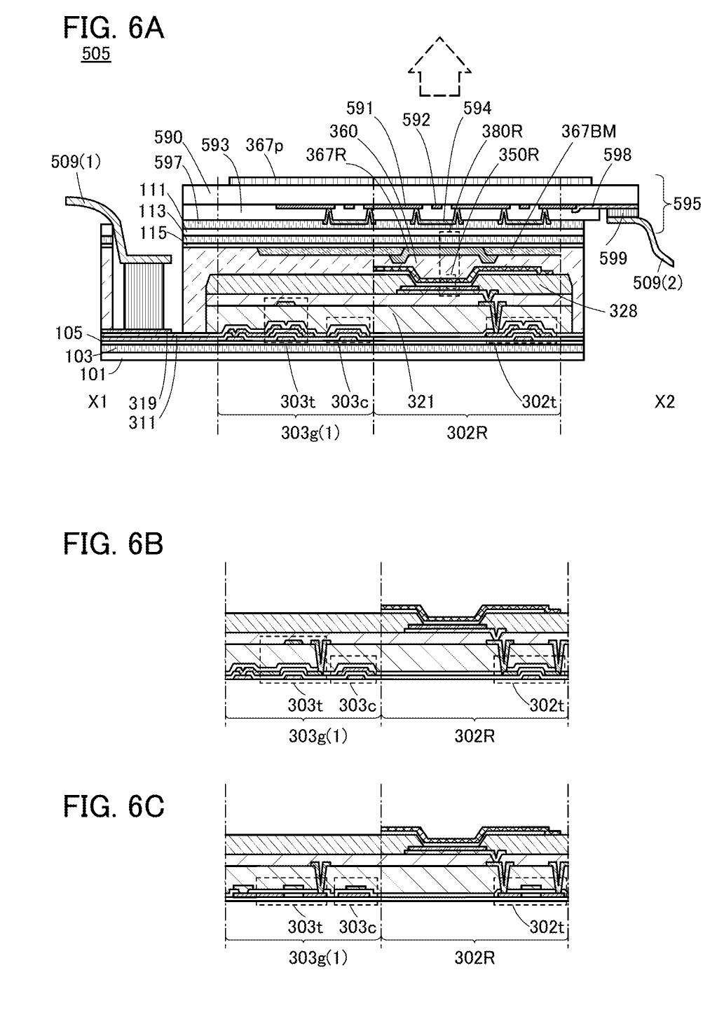

FIGS. 5A and 5B are perspective views of an input/output device 505. Note that FIGS. 5A and 5B illustrate only main components for simplicity. FIGS. 6A to 6C are each a cross-sectional view taken along the dashed-dotted line X1-X2 in FIG. 5A.

As illustrated in FIGS. 5A and 5B, the input/output device 505 includes a display portion 501, the scan line driver circuit 303g(1), a touch sensor 595, and the like. Furthermore, the input/output device 505 includes the substrate 101, the substrate 111, and a substrate 590.

The input/output device 505 includes a plurality of pixels and a plurality of wirings 311. The plurality of wirings 311 can supply signals to the pixels. The plurality of wirings 311 are led to a peripheral portion of the substrate 101, and part of the plurality of wirings 311 form the terminal 319. The terminal 319 is electrically connected to an FPC 509(1).

The input/output device 505 includes the touch sensor 595 and a plurality of wirings 598. The plurality of wirings 598 are electrically connected to the touch sensor 595. The plurality of wirings 598 are led to a peripheral portion of the substrate 590, and part of the plurality of wirings 598 form a terminal. The terminal is electrically connected to an FPC 509(2). Note that in FIG. 5B, electrodes, wirings, and the like of the touch sensor 595 provided on the back side of the substrate 590 (the side facing the substrate 101) are indicated by solid lines for clarity.

As the touch sensor 595, for example, a capacitive touch sensor can be used. Examples of the capacitive touch sensor include a surface capacitive touch sensor and a projected capacitive touch sensor. An example of using a projected capacitive touch sensor is described here.

Examples of the projected capacitive touch sensor include a self capacitive touch sensor and a mutual capacitive touch sensor, which differ mainly in the driving method. The use of a mutual capacitive type is preferred because multiple points can be sensed simultaneously.

Note that a variety of sensors that can sense the closeness or the contact of a sensing target such as a finger can be used as the touch sensor 595.

The projected capacitive touch sensor 595 includes electrodes 591 and electrodes 592. The electrodes 591 are electrically connected to any of the plurality of wirings 598, and the electrodes 592 are electrically connected to any of the other wirings 598.

The electrodes 592 each have a shape of a plurality of quadrangles arranged in one direction with one corner of a quadrangle connected to one corner of another quadrangle as illustrated in FIGS. 5A and 5B.

The electrodes 591 each have a quadrangular shape and are arranged in a direction intersecting with the direction in which the electrodes 592 extend. Note that the plurality of electrodes 591 is not necessarily arranged in the direction orthogonal to one electrode 592 and may be arranged to intersect with one electrode 592 at an angle of less than 90 degrees.

A wiring 594 intersects with the electrode 592. The wiring 594 electrically connects two electrodes 591 between which one of the electrodes 592 is positioned. The intersecting area of the one of the electrodes 592 and the wiring 594 is preferably as small as possible. Such a structure allows a reduction in the area of a region where the electrodes are not provided, reducing unevenness in transmittance. As a result, unevenness in luminance of light transmitted through the touch sensor 595 can be reduced.

Note that the shapes of the electrodes 591 and the electrodes 592 are not limited to the above-mentioned shapes and can be any of a variety of shapes. For example, a plurality of first electrodes each having a stripe shape may be provided so that space between two adjacent first electrodes are reduced as much as possible, and a plurality of second electrodes each having a stripe shape may be provided so as to intersect the first electrodes with an insulating layer sandwiched between the first electrodes and the second electrodes. In that case, two adjacent second electrodes may be spaced apart from each other. In that case, it is preferable to provide, between the two adjacent second electrodes, a dummy electrode which is electrically insulated from these electrodes, whereby the area of a region having a different transmittance can be reduced.

As illustrated in FIG. 6A, the input/output device 505 includes the substrate 101, the bonding layer 103, the insulating layer 105, the substrate 111, the bonding layer 113, and the insulating layer 115. The substrates 101 and 111 are attached to each other with the bonding layer 360.

A bonding layer 597 attaches the substrate 590 to the substrate 111 so that the touch sensor 595 overlaps with the display portion 501. The bonding layer 597 has a light-transmitting property.

The electrodes 591 and the electrodes 592 are formed using a light-transmitting conductive material. As a light-transmitting conductive material, a conductive oxide such as indium oxide, indium tin oxide, indium zinc oxide, zinc oxide, or zinc oxide to which gallium is added can be used. Note that a film including graphene may be used as well. The film including graphene can be formed, for example, by reducing a film including graphene oxide. As a reducing method, a method with application of heat or the like can be employed.

The electrodes 591 and the electrodes 592 may be formed by depositing a light-transmitting conductive material on the substrate 590 by a sputtering method and then removing an unnecessary portion by a variety of patterning technique such as photolithography.

The electrodes 591 and the electrodes 592 are covered with an insulating layer 593. Furthermore, openings reaching the electrodes 591 are formed in the insulating layer 593, and the wiring 594 electrically connects the adjacent electrodes 591. A light-transmitting conductive material can be favorably used as the wiring 594 because the aperture ratio of the input/output device can be increased. Moreover, a material with higher conductivity than the conductivities of the electrodes 591 and the electrodes 592 can be favorably used for the wiring 594 because electric resistance can be reduced.

Note that an insulating layer covering the insulating layer 593 and the wiring 594 may be provided to protect the touch sensor 595.

Furthermore, a connection layer 599 electrically connects the wirings 598 to the FPC 509(2).

The display portion 501 includes a plurality of pixels arranged in a matrix. Each pixel has the same structure as Structure Example 1; thus, description is omitted.

Any of various kinds of transistors can be used in the input/output device. A structure in the case of using bottom-gate transistors is illustrated in FIGS. 6A and 6B.

For example, a semiconductor layer containing an oxide semiconductor, amorphous silicon, or the like can be used in the transistor 302t and the transistor 303t illustrated in FIG. 6A.

For example, a semiconductor layer containing polycrystalline silicon that is obtained by crystallization process such as laser annealing can be used in the transistor 302t and the transistor 303t illustrated in FIG. 6B.

A structure in the case of using top-gate transistors is illustrated in FIG. 6C.

For example, a semiconductor layer including polycrystalline silicon, a single crystal silicon film that is transferred from a single crystal silicon substrate, or the like can be used in the transistor 302t and the transistor 303t illustrated in FIG. 6C.

### Structure Example 3

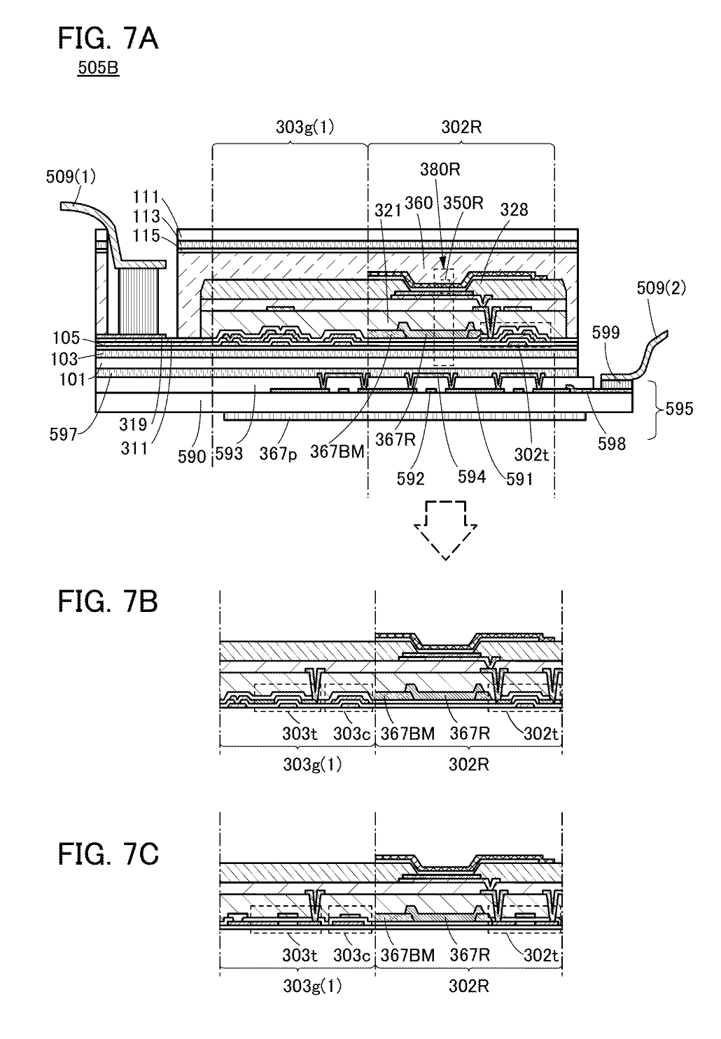

FIGS. 7A to 7C are cross-sectional views of an input/output device 505B. The input/output device 505B described in this embodiment is different from the input/output device 505 in Structure Example 2 in that received image data is displayed on the side where the transistors are provided and that the touch sensor is provided on the substrate 101 side of the display portion. Different structures will be described in detail below, and the above description is referred to for the other similar structures.

The coloring layer 367R is positioned in a region overlapping with the light-emitting element 350R. The light-emitting element 350R illustrated in FIG. 7A emits light to the side where the transistor 302t is provided. Accordingly, part of light emitted from the light-emitting element 350R passes through the coloring layer 367R and is emitted to the outside of the light-emitting module 380R as indicated by an arrow in FIG. 7A.

The input/output device 505B includes the light-blocking layer 367BM on the light extraction side. The light-blocking layer 367BM is provided so as to surround the coloring layer (e.g., the coloring layer 367R).

The touch sensor 595 is provided not on the substrate 111 side but on the substrate 101 side (see FIG. 7A).

The bonding layer 597 attaches the substrate 590 to the substrate 101 so that the touch sensor 595 overlaps with the display portion. The bonding layer 597 has a light-transmitting property.

Note that a structure in the case of using bottom-gate transistors in the display portion 501 is illustrated in FIGS. 7A and 7B.

For example, a semiconductor layer containing an oxide semiconductor, amorphous silicon, or the like can be used in the transistor 302t and the transistor 303t illustrated in FIG. 7A.

For example, a semiconductor layer containing polycrystalline silicon can be used in the transistor 302t and the transistor 303t illustrated in FIG. 7B.

A structure in the case of using top-gate transistors is illustrated in FIG. 7C.

For example, a semiconductor layer containing polycrystalline silicon, a single crystal silicon film that is transferred from a single crystal silicon substrate, or the like can be used in the transistor 302t and the transistor 303t illustrated in FIG. 7C.

### Structure Example 4

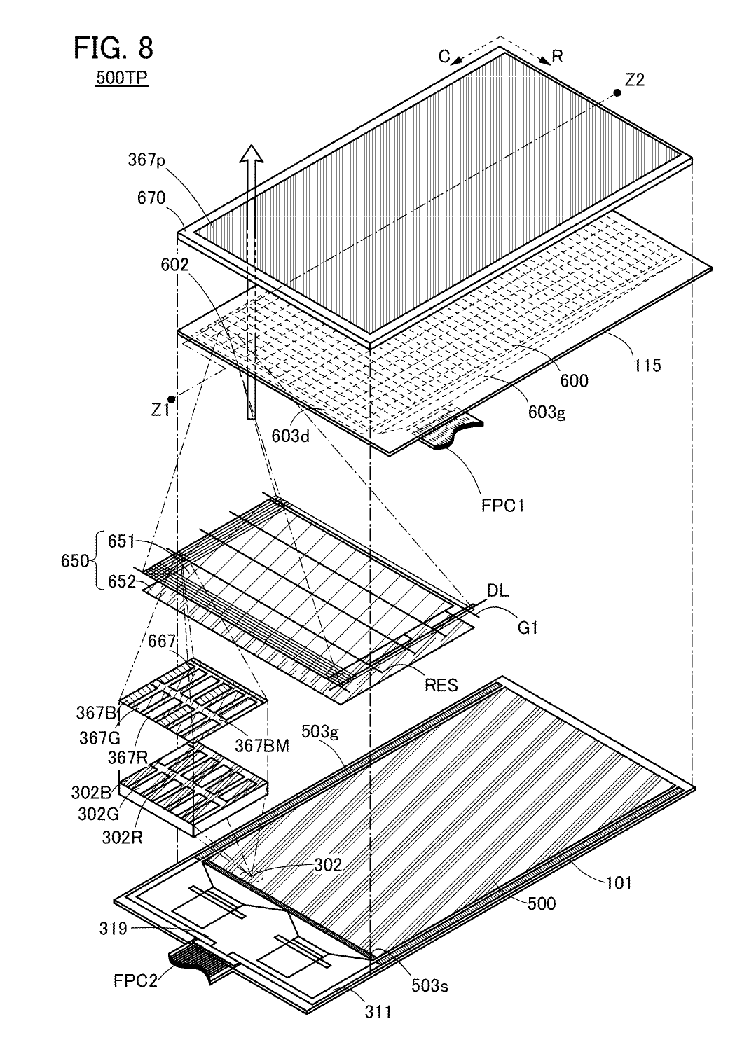

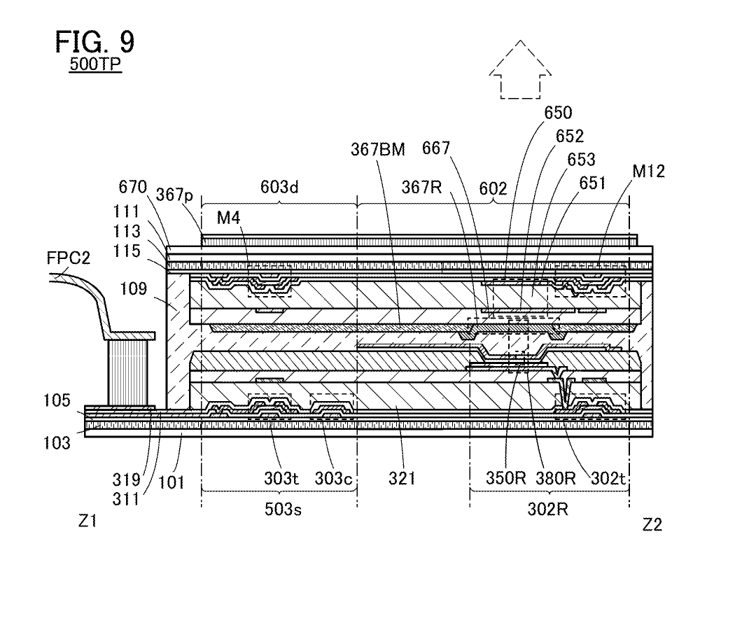

As illustrated in FIG. 8, an input/output device 500TP includes a display portion 500 and an input portion 600 that overlap each other. FIG. 9 is a cross-sectional view taken along the dashed-dotted line Z1-Z2 in FIG. 8.

Individual components included in the input/output device 500TP are described below. Note that these components cannot be clearly distinguished and one component also serves as another component or include part of another component in some cases. Note that the input/output device 500TP in which the input portion 600 overlaps with the display portion 500 is also referred to as a touch panel.

The input portion 600 includes a plurality of sensing units 602 arranged in a matrix. The input portion 600 also includes a selection signal line G1, a control line RES, a signal line DL, and the like.

The selection signal line G1 and the control line RES are electrically connected to the plurality of sensing units 602 that are arranged in the row direction (indicated by the arrow R in FIG. 8). The signal line DL is electrically connected to the plurality of sensing units 602 that are arranged in the column direction (indicated by the arrow C in FIG. 8).

The sensing unit 602 senses an object that is close thereto or in contact therewith and supplies a sensing signal. For example, the sensing unit 602 senses, for example, capacitance, illuminance, magnetic force, electric waves, or pressure and supplies data based on the sensed physical quantity. Specifically, a capacitor, a photoelectric conversion element, a magnetic sensing element, a piezoelectric element, a resonator, or the like can be used as the sensing element.

The sensing unit 602 senses, for example, a change in capacitance between the sensing unit 602 and an object close thereto or an object in contact therewith.

Note that when an object having a dielectric constant higher than that of the air, such as a finger, comes close to a conductive film in the air, the capacitance between the finger and the conductive film changes. The sensing unit 602 can sense the capacitance change and supply sensing data.

For example, the capacitance change causes charge distribution between the conductive film and the capacitor, leading to voltage change across the capacitor. This voltage change can be used as a sensing signal.

The sensing unit 602 is provided with a sensor circuit. The sensor circuit is electrically connected to the selection signal line G1, the control line RES, the signal line DL, or the like.

The sensor circuit includes a transistor, a sensor element, or the like. For example, a conductive film and a capacitor electrically connected to the conductive film can be used for the sensor circuit. A capacitor and a transistor electrically connected to the capacitor can also be used for the sensor circuit.

For example, a capacitor 650 including an insulating layer 653, and a first electrode 651 and a second electrode 652 between which the insulating layer 653 is provided can be used for the sensor circuit (see FIG. 9). The voltage between the electrodes of the capacitor 650 changes when an object comes close to the conductive film that is electrically connected to one electrode of the capacitor 650.

The sensing unit 602 includes a switch that can be turned on or off in accordance with a control signal. For example, a transistor M12 can be used as the switch.

A transistor which amplifies a sensing signal can be used in the sensor unit 602.

Transistors manufactured through the same process can be used as the transistor that amplifies a sensing signal and the switch. This allows the input portion 600 to be provided through a simplified process.

The sensing unit includes a plurality of window portions 667 arranged in a matrix. The window portion 667 transmits visible light, and a light-blocking layer BM may be provided between the plurality of window portions 667.

A coloring layer is provided in a position overlapping with the window portion 667 in the input/output device 500TP. The coloring layer transmits light of a predetermined color. Note that the coloring layer can be called a color filter. For example, a coloring layer 367B transmitting blue light, a coloring layer 367G transmitting green light, and a coloring layer 367R transmitting red light can be used. A coloring layer transmitting yellow light or a coloring layer transmitting white light may also be used.

The display portion 500 includes the plurality of pixels 302 arranged in a matrix. The pixel 302 is positioned so as to overlap with the window portions 667 of the input portion 600. The pixels 302 may be arranged at higher resolution than the sensing units 602. Each pixel has the same structure as Structure Example 1; thus, description is omitted.

The input/output device 500TP includes the input portion 600 that includes the plurality of sensing units 602 arranged in a matrix and the window portions 667 transmitting visible light, the display portion 500 that includes the plurality of pixels 302 overlapping with the window portions 667, and the coloring layers between the window portions 667 and the pixels 302. In addition, each sensing unit is provided with a switch with which interference in another sensing unit can be reduced.

With such a structure, sensing data sensed by each sensing unit can be supplied together with the positional data of the sensing unit. In addition, the sensing data associated with the positional data of the pixel for displaying an image can be supplied. Electrical continuity between a sensing unit that does not supply sensing data and the signal line is not established, whereby interference in a sensing unit that supplies a sensing signal can be reduced. Consequently, the novel input/output device 500TP that is highly convenient or highly reliable can be provided.

For example, the input portion 600 of the input/output device 500TP can sense sensing data and supply the sensing data together with the positional data. Specifically, a user of the input/output device 500TP can make a variety of gestures (e.g., tap, drag, swipe, and pinch-in operation) using, as a pointer, his/her finger or the like on the input portion 600.

The input portion 600 can sense a finger or the like that comes close to or is in contact with the input portion 600 and supply sensing data including a sensed position, path, or the like.

An arithmetic unit determines whether or not supplied data satisfies a predetermined condition on the basis of a program or the like and executes an instruction associated with a predetermined gesture.

Thus, a user of the input portion 600 can make the predetermined gesture with his/her finger or the like and make the arithmetic unit execute an instruction associated with the predetermined gesture.

For example, first, the input portion 600 of the input/output device 500TP selects one sensing unit X from the plurality of sensing units that can supply sensing data to one signal line. Then, electrical continuity between the signal line and the sensing units other than the sensing unit X is not established. This can reduce interference of the other sensing units in the sensing unit X.

Specifically, interference of sensing elements of the other sensing units in a sensing element of the sensing unit X can be reduced.

For example, in the case where a capacitor and a conductive film to which one electrode of the capacitor is electrically connected are used for the sensing element, interference of the potentials of the conductive films of the other sensing units in the potential of the conductive film of the sensing unit X can be reduced.

Thus, the input/output device 500TP can drive the sensing unit and supply sensing data independently of its size. The input/output device 500TP can have a variety of sizes, for example, ranging from a size for a hand-held device to a size for an electronic blackboard.

The input/output device 500TP can be folded and unfolded. Even in the case where interference of the other sensing units in the sensing unit X is different between the folded state and the unfolded state, the sensing unit can be driven and sensing data can be supplied without dependence on the state of the input/output device 500TP.

The display portion 500 of the input/output device 500TP can be supplied with display data. For example, an arithmetic unit can supply the display data.

In addition to the above structure, the input/output device 500TP can have the following structure.

The input/output device 500TP may include a driver circuit 603g or a driver circuit 603d. In addition, the input/output device 500TP (or driver circuit) may be electrically connected to an FPC1.

The driver circuit 603g can supply selection signals at predetermined timings, for example. Specifically, the driver circuit 603g supplies selection signals to the selection signal lines G1 row by row in a predetermined order. Any of a variety of circuits can be used as the driver circuit 603g. For example, a shift register, a flip-flop circuit, a combination circuit, or the like can be used.

The driver circuit 603d supplies sensing data on the basis of a sensing signal supplied from the sensing unit 602. Any of a variety of circuits can be used as the driver circuit 603d. For example, a circuit that can form a source follower circuit or a current mirror circuit by being electrically connected to the sensing circuit in the sensing unit can be used as the driver circuit 603d. In addition, an analog-to-digital converter circuit that converts a sensing signal into a digital signal may be provided in the driver circuit 603d.

The FPC1 supplies a timing signal, a power supply potential, or the like and is supplied with a sensing signal.

The input/output device 500TP may include a driver circuit 503g, a driver circuit 503s, a wiring 311, and a terminal 319. In addition, the input/output device 500TP (or driver circuit) may be electrically connected to an FPC2.

In addition, a protective layer 670 that prevents damage and protects the input/output device 500TP may be provided. For example, a ceramic coat layer or a hard coat layer can be used as the protective layer 670. Specifically, a layer containing aluminum oxide or an ultraviolet curable resin can be used.

In the case of a transflective liquid crystal display or a reflective liquid crystal display, some of or all of pixel electrodes function as reflective electrodes. For example, some or all of pixel electrodes are formed to contain aluminum or silver.

Furthermore, a memory circuit such as an SRAM can be provided under the reflective electrodes, leading to lower power consumption. A structure suitable for employed display elements can be selected from among a variety of structures of pixel circuits.

This embodiment can be combined with any other embodiment as appropriate.

### Embodiment 3

In this embodiment, electronic devices and lighting devices of one embodiment of the present invention will be described with reference to drawings.

By applying one embodiment of the present invention, electronic devices and lighting devices can be made lightweight, thin, and flexible. For example, the light-emitting device (which includes the display device including a light-emitting element) described in Embodiment 1 and the input/output device described in Embodiment 2 can be used for a flexible display portion of an electronic device and a flexible light-emitting portion of a lighting device. Furthermore, an electronic device or a lighting device having high reliability and high resistance to repeated bending can be manufactured by one embodiment of the present invention.

Examples of electronic devices are television devices (also referred to as TV or television receivers), monitors for computers and the like, cameras such as digital cameras and digital video cameras, digital photo frames, cellular phones (also referred to as portable telephone devices), portable game machines, portable information terminals, audio playback devices, large game machines such as pin-ball machines, and the like.

The electronic device or the lighting device of one embodiment of the present invention has flexibility and therefore can be incorporated along a curved inside/outside wall surface of a house or a building or a curved interior/exterior surface of a car.

The electronic device of one embodiment of the present invention may include a light-emitting device or an input/output device, and a secondary battery. In that case, it is preferable that the secondary battery be capable of being charged by non-contact power transmission.

Examples of the secondary battery include a lithium ion secondary battery such as a lithium polymer battery using a gel electrolyte (lithium ion polymer battery), a nickel-hydride battery, a nickel-cadmium battery, an organic radical battery, a lead-acid battery, an air secondary battery, a nickel-zinc battery, and a silver-zinc battery.

An electronic device of one embodiment of the present invention may include a light-emitting device or an input/output device, an antenna, and a secondary battery. Receiving a signal with the antenna enables a display portion to display video, information, and the like. When the electronic device includes a secondary battery, the antenna may be used for non-contact power transmission.

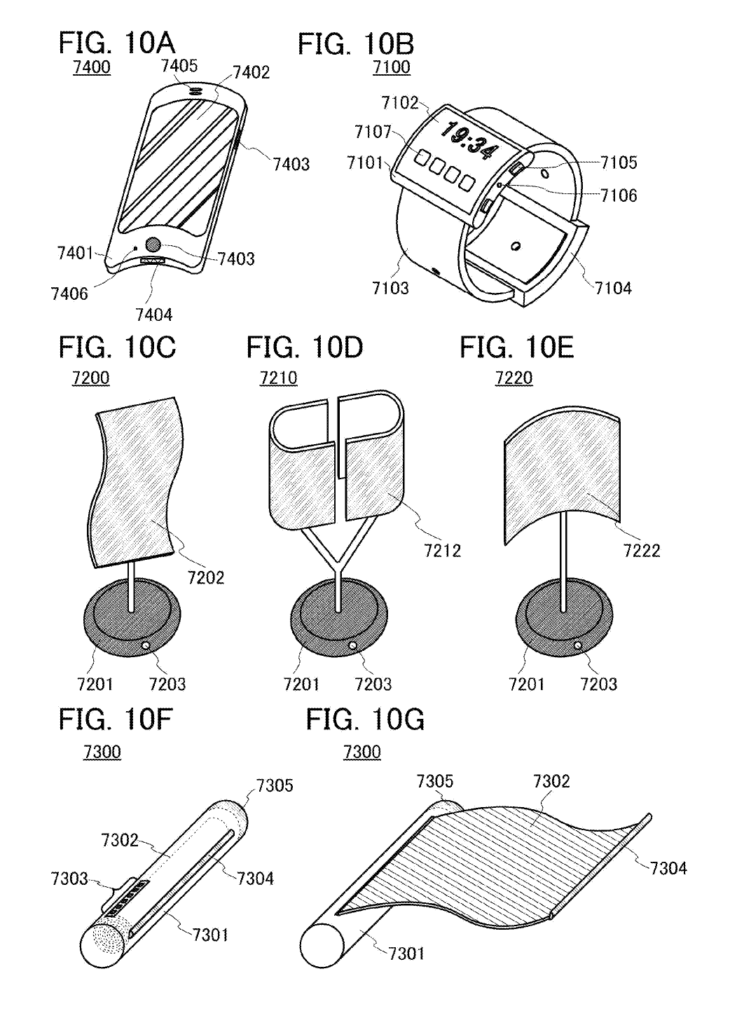

FIG. 10A illustrates an example of a cellular phone. A cellular phone 7400 includes a display portion 7402 incorporated in a housing 7401, an operation button 7403, an external connection port 7404, a speaker 7405, a microphone 7406, and the like. Note that the cellular phone 7400 is manufactured using the light-emitting device or input/output device of one embodiment of the present invention for the display portion 7402. One embodiment of the present invention makes it possible to provide a highly reliable cellular phone having a curved display portion with a high yield.

When the display portion 7402 of the cellular phone 7400 in FIG. 10A is touched with a finger or the like, data can be input into the cellular phone 7400. Moreover, operations such as making a call and inputting a letter can be performed by touch on the display portion 7402 with a finger or the like.

With the operation button 7403, power ON or OFF can be switched. In addition, a variety of images displayed on the display portion 7402 can be switched; switching a mail creation screen to a main menu screen, for example.

FIG. 10B is an example of a wrist-watch-type portable information terminal. A portable information terminal 7100 includes a housing 7101, a display portion 7102, a band 7103, a buckle 7104, an operation button 7105, an input/output terminal 7106, and the like.

The portable information terminal 7100 is capable of executing a variety of applications such as mobile phone calls, e-mailing, reading and editing texts, music reproduction, Internet communication, and a computer game.

The display surface of the display portion 7102 is bent, and images can be displayed on the bent display surface. Furthermore, the display portion 7102 includes a touch sensor, and operation can be performed by touching the screen with a finger, a stylus, or the like. For example, by touching an icon 7107 displayed on the display portion 7102, an application can be started.

With the operation button 7105, a variety of functions such as time setting, power ON/OFF, ON/OFF of wireless communication, setting and cancellation of manner mode, and setting and cancellation of power saving mode can be performed. For example, the functions of the operation button 7105 can be set freely by setting the operating system incorporated in the portable information terminal 7100.

The portable information terminal 7100 can employ near field communication that is a communication method based on an existing communication standard. In that case, for example, mutual communication between the portable information terminal 7100 and a headset capable of wireless communication can be performed, and thus hands-free calling is possible.

Moreover, the portable information terminal 7100 includes the input/output terminal 7106, and data can be directly transmitted to and received from another information terminal via a connector. Charging through the input/output terminal 7106 is possible. Note that the charging operation may be performed by wireless power feeding without using the input/output terminal 7106.

The display portion 7102 of the portable information terminal 7100 includes the light-emitting device or input/output device of one embodiment of the present invention. One embodiment of the present invention makes it possible to provide a highly reliable portable information terminal having a curved display portion with a high yield.

FIGS. 10C to 10E illustrate examples of a lighting device. Lighting devices 7200, 7210, and 7220 each include a stage 7201 provided with an operation switch 7203 and a light-emitting portion supported by the stage 7201.

The lighting device 7200 illustrated in FIG. 10C includes a light-emitting portion 7202 having a wave-shaped light-emitting surface, which is a good-design lighting device.

A light-emitting portion 7212 included in the lighting device 7210 in FIG. 10D has two convex-curved light-emitting portions symmetrically placed. Thus, all directions can be illuminated with the lighting device 7210 as a center.

The lighting device 7220 illustrated in FIG. 10E includes a concave-curved light-emitting portion 7222. This is suitable for illuminating a specific range because light emitted from the light-emitting portion 7222 is collected to the front of the lighting device 7220.

The light-emitting portion included in each of the lighting devices 7200, 7210, and 7220 are flexible; thus, the light-emitting portion may be fixed on a plastic member, a movable frame, or the like so that an emission surface of the light-emitting portion can be bent freely depending on the intended use.

Note that although the lighting device in which the light-emitting portion is supported by the stage is described as an example here, a housing provided with a light-emitting portion can be fixed on a ceiling or suspended from a ceiling. Since the light-emitting surface can be curved, the light-emitting surface can be bent concavely so that a particular region is brightly illuminated, or bent convexly so that the whole room is brightly illuminated.

Here, each light-emitting portion includes the light-emitting device or input/output device of one embodiment of the present invention. One embodiment of the present invention makes it possible to provide a highly reliable lighting device having a curved light-emitting portion with a high yield.

FIG. 10F illustrates an example of a portable display device. A display device 7300 includes a housing 7301, a display portion 7302, operation buttons 7303, a display portion pull 7304, and a control portion 7305.

The display device 7300 includes a rolled flexible display portion 7302 in the cylindrical housing 7301.

The display device 7300 can receive a video signal with the control portion 7305 and can display the received video on the display portion 7302. In addition, a battery is included in the control portion 7305. Moreover, a terminal portion for connecting a connector may be included in the control portion 7305 so that a video signal or power can be directly supplied from the outside with a wiring.

With the operation buttons 7303, power ON/OFF, switching of displayed videos, and the like can be performed.

FIG. 10G illustrates the display device 7300 in a state where the display portion 7302 is pulled out with the display portion pull 7304. Videos can be displayed on the display portion 7302 in this state. Furthermore, the operation buttons 7303 on the surface of the housing 7301 allow one-handed operation. The operation buttons 7303 are provided not in the center of the housing 7301 but on one side of the housing 7301 as illustrated in FIG. 10F, which makes one-handed operation easy.

Note that a reinforcement frame may be provided for a side portion of the display portion 7302 so that the display portion 7302 has a flat display surface when pulled out.

Note that in addition to this structure, a speaker may be provided for the housing so that sound is output with an audio signal received together with a video signal.

The display portion 7302 includes the light-emitting device or input/output device of one embodiment of the present invention. One embodiment of the present invention makes it possible to provide a lightweight and highly reliable display device with a high yield.

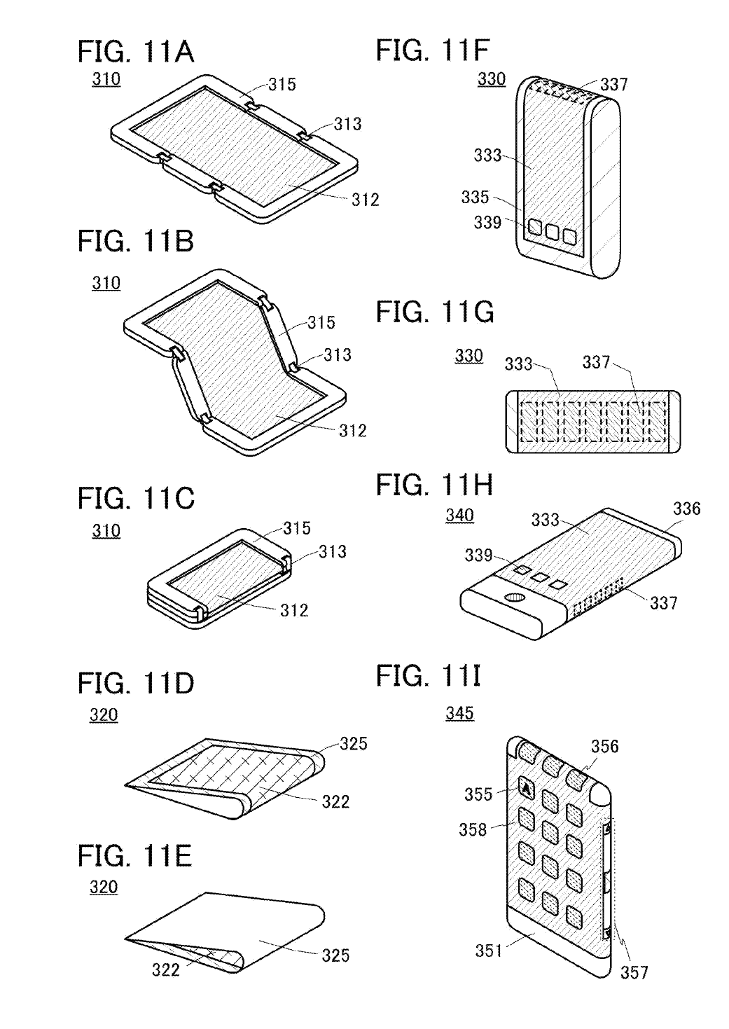

FIGS. 11A to 11C illustrate a foldable portable information terminal 310. FIG. 11A illustrates the portable information terminal 310 that is opened. FIG. 11B illustrates the portable information terminal 310 that is being opened or being folded. FIG. 11C illustrates the portable information terminal 310 that is folded. The portable information terminal 310 is highly portable when folded. The portable information terminal 310 is highly browsable when opened because of its seamless large display region.

A display panel 312 is supported by three housings 315 joined together by hinges 313. By folding the portable information terminal 310 at a connection portion between two housings 315 with the hinges 313, the portable information terminal 310 can be reversibly changed in shape from an opened state to a folded state. The light-emitting device or input/output device of one embodiment of the present invention can be used for the display panel 312. For example, a light-emitting device or an input/output device that can be bent with a radius of curvature of greater than or equal to 1 mm and less than or equal to 150 mm can be used.

FIGS. 11D and 11E each illustrate a foldable portable information terminal 320. FIG. 11D illustrates the portable information terminal 320 that is folded so that a display portion 322 is on the outside. FIG. 11E illustrates the portable information terminal 320 that is folded so that the display portion 322 is on the inside. When the portable information terminal 320 is not used, the portable information terminal 320 is folded so that a non-display portion 325 faces the outside, whereby the display portion 322 can be prevented from being contaminated or damaged. The light-emitting device or input/output device of one embodiment of the present invention can be used for the display portion 322.

FIG. 11F is a perspective view illustrating an external shape of the portable information terminal 330. FIG. 11G is a top view of the portable information terminal 330. FIG. 11H is a perspective view illustrating an external shape of a portable information terminal 340.

The portable information terminals 330 and 340 each function as, for example, one or more of a telephone set, a notebook, an information browsing system, and the like. Specifically, the portable information terminals 330 and 340 each can be used as a smartphone.

The portable information terminals 330 and 340 can display characters and image information on its plurality of surfaces. For example, three operation buttons 339 can be displayed on one surface (FIGS. 11F and 11H). In addition, information 337 indicated by dashed rectangles can be displayed on another surface (FIGS. 11G and 11H). Examples of the information 337 include notification from a social networking service (SNS), display indicating reception of an e-mail or an incoming call, the title of an e-mail or the like, the sender of an e-mail or the like, the date, the time, remaining battery, and the reception strength of an antenna. Alternatively, the operation buttons 339, an icon, or the like may be displayed in place of the information 337. Although FIGS. 11F and 11G illustrate an example in which the information 337 is displayed at the top, one embodiment of the present invention is not limited thereto. For example, the information 337 may be displayed on the side as in the portable information terminal 340 in FIG. 11H.

For example, a user of the portable information terminal 330 can see the display (here, the information 337) with the portable information terminal 330 put in a breast pocket of his/her clothes.

Specifically, a caller's phone number, name, or the like of an incoming call is displayed in a position that can be seen from above the portable information terminal 330. Thus, the user can see the display without taking out the portable information terminal 330 from the pocket and decide whether to answer the call.

The light-emitting device or input/output device of one embodiment of the present invention can be used for a display portion 333 mounted in each of a housing 335 of the portable information terminal 330 and a housing 336 of the portable information terminal 340. One embodiment of the present invention makes it possible to provide a highly reliable portable information terminal having a curved display portion with a high yield.

As in a portable information terminal 345 illustrated in FIG. 11I, data may be displayed on three or more surfaces. Here, data 355, data 356, and data 357 are displayed on different surfaces.

For a display portion 358 included in a housing 351 of the portable information terminal 345, the light-emitting device or input/output device of one embodiment of the present invention can be used. One embodiment of the present invention makes it possible to provide a highly reliable portable information terminal having a curved display portion with a high yield.

This embodiment can be combined with any other embodiment as appropriate.

### Example 1

In this example, an insulating layer that can be used in one embodiment of the present invention will be described. Specifically, the structure of an insulating layer that can be favorably used as the insulating layer 105 and/or the insulating layer 115 described in Embodiment 1 is described.

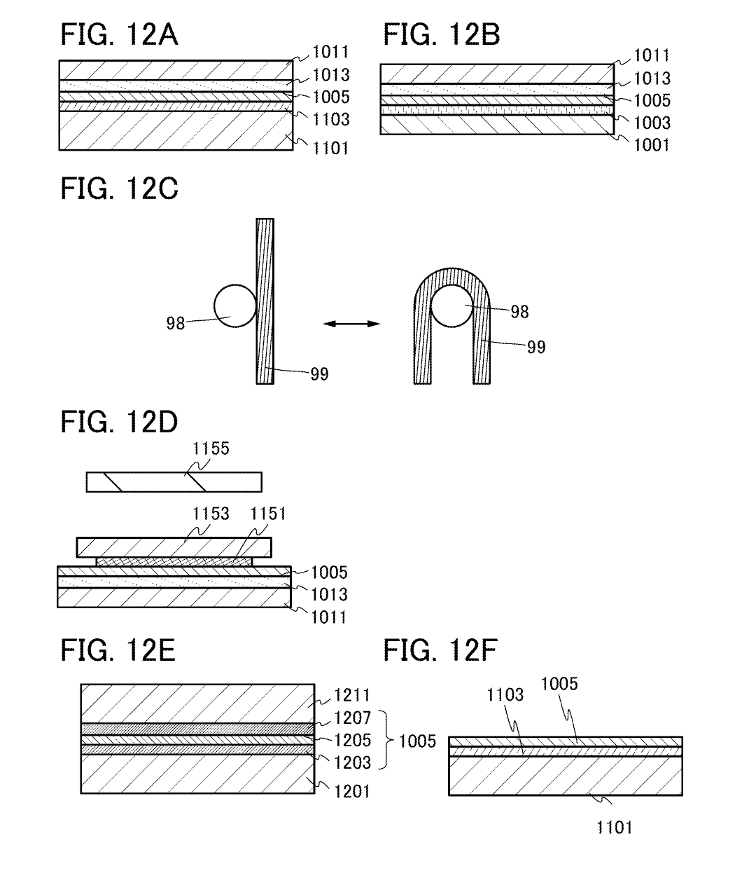

A method for fabricating samples of this example is described with reference to FIG. 12A.

First, an approximately 100-nm-thick silicon oxynitride film was formed as a base film (not illustrated) over a glass substrate serving as the formation substrate 1101. The silicon oxynitride film was formed by a plasma CVD method under the following conditions: the flow rates of a silane gas and an N₂O gas were 10 sccm and 1200 sccm, respectively, the power supply was 30 W, the pressure was 22 Pa, and the substrate temperature was 330° C.

Next, an approximately 30-nm-thick tungsten film serving as the peeling layer 1103 was formed over the base film. The tungsten film was formed by a sputtering method under the following conditions: the flow rate of an Ar gas was 100 sccm, the power supply was 60 kW, the pressure was 2 Pa, and the substrate temperature was 100° C.

Next, nitrous oxide (N₂O) plasma treatment was performed. The N₂O plasma treatment was performed for 240 seconds under the following conditions: the flow rate of an N₂O gas was 100 sccm, the power supply was 500 W, the pressure was 100 Pa, and the substrate temperature was 330° C.

Next, a layer to be peeled 1005 was formed over the peeling layer 1103. The structure of the layer to be peeled 1005 is a stack in which a first silicon oxynitride film, a first silicon nitride film, a second silicon oxynitride film, a second silicon nitride film, and a third silicon oxynitride film were stacked in this order on the peeling layer 1103 side.

As the layer to be peeled 1005, first, the first silicon oxynitride film was formed to a thickness of approximately 600 nm over the peeling layer 1103. The first silicon oxynitride film was formed by a plasma CVD method under the following conditions: the flow rates of a silane gas and an N₂O gas were 75 sccm and 1200 sccm, respectively, the power supply was 120 W, the pressure was 70 Pa, and the substrate temperature was 330° C.

Next, the first silicon nitride film was formed to a thickness of approximately 200 nm over the first silicon oxynitride film. The first silicon nitride film was formed by a plasma CVD method under the following conditions: the flow rates of a silane gas, an H₂ gas, and an NH₃ gas were 30 sccm, 800 sccm, and 300 sccm, respectively, the power supply was 600 W, the pressure was 60 Pa, and the substrate temperature was 330° C.

Next, the second silicon oxynitride film was formed to a thickness of approximately 200 nm over the first silicon nitride film. The second silicon oxynitride film was formed by a plasma CVD method under the following conditions: the flow rates of a silane gas and an N₂O gas were 50 sccm and 1200 sccm, respectively, the power supply was 120 W, the pressure was 70 Pa, and the substrate temperature was 330° C.

Next, the second silicon nitride film was formed to a thickness of approximately 100 nm over the second silicon oxynitride film. The second silicon nitride film was formed under the same conditions as the first silicon nitride film.

Next, the third silicon oxynitride film was formed to a thickness of approximately 100 nm over the second silicon nitride film. The third silicon oxynitride film was formed under the same conditions as the base film.

After that, heat treatment was performed at 450° C. in a nitrogen atmosphere for one hour.

Then, the layer to be peeled 1005 was attached to a substrate 1011 with a bonding layer 1013. A 20-μm-thick film was used as the substrate 1011. The bonding layer 1013 was formed using a two-part curable epoxy-based resin. FIG. 12A illustrates the stacked-layer structure of the sample at this time.

Table 1 shows the stress of the layer to be peeled 1005 and the stress of each of the insulating films having a single-layer structure included in the layer to be peeled 1005. In Table 1, a negative value of the stress represents that the layer has compressive stress and a positive value of the stress represents that the layer has tensile stress. The samples used to measure the stress were each fabricated by forming a film, the stress of which was targeted for measurement, over a silicon substrate and then by performing heat treatment at 450° C. in a nitrogen atmosphere for one hour.

TABLE 1

| | Thickness | Conditions | Stress (MPa) |
|---|---|---|---|
| Third silicon | 100 nm | SiH₄ = 10 sccm, | −196 |
| oxynitride film | | N₂O = 1200 sccm, | |
| | | 30 W, 22 Pa, 330° C. | |
| Second silicon | 100 nm | SiH₄ = 30 sccm, | −433* |
| nitride film | | H₂ = 800 sccm , | |
| | | NH₃ = 300 sccm, | |
| | | 600 W, 60 Pa, 330° C. | |
| Second silicon | 200 nm | SiH₄ = 50 sccm, | −14.9 |
| oxynitride film | | N₂O = 1200 sccm, | |
| | | 120 W, 70 Pa, 330° C. | |
| First silicon | 200 nm | SiH₄ = 30 sccm, | −433 |
| nitride film | | H₂ = 800 sccm , | |
| | | NH₃ = 300 sccm, | |
| | | 600 W, 60 Pa, 330° C. | |
| First silicon | 600 nm | SiH₄ = 75 sccm, | 21.0 |
| oxynitride film | | N₂O = 1200 sccm, | |
| | | 120 W, 70 Pa, 330° C. | |

| | |
|---|---|
| Layer to be peeled 1005 | −155 |

*stress value in the case where the thickness was 200 nm

Next, the layer to be peeled 1005 was peeled from the formation substrate 1101. In the layer to be peeled 1005 which was peeled from the formation substrate 1101, a crack that can be recognized with eyes did not occur. The above result showed that the layer to be peeled 1005 of this example was less likely to generate a crack at peeling.

Note that as shown in Table 1, the stress of the layer to be peeled 1005 was −155 MPa. In contrast, when a value of the stress of the layer to be peeled is positive (such stress corresponds to tensile stress), a crack that can be recognized with eyes might occur by peeling the layer to be peeled from the formation substrate. This result suggests that the layer to be peeled 1005 of this example is less likely to generate a crack at peeling because of having compressive stress.

Furthermore, the layer to be peeled 1005 was exposed by peeling the formation substrate 1101. In the following description, two types of flexible samples were fabricated. One of the samples is a flexible sample A in which the exposed layer to be peeled 1005 and the substrate 1001 were attached to each other with a bonding layer 1003 (see FIG. 12B). The other sample is a flexible sample B in which an anisotropic conductive film 1151 was provided over the exposed layer to be peeled 1005 (see FIG. 12D). Note that the flexible sample B was in a state with a protective film of a film used for the substrate 1011 (the protective film is also referred to as a separate film and, here, is a 100-μm-thick film).

The flexible sample A was subjected to a preservation test. Note that the same material as the bonding layer 1013 was used for the bonding layer 1003, and the same material as the substrate 1011 was used for the substrate 1001.

Two types of flexible samples A were prepared. One of the samples was preserved at a temperature of 60° C. and a humidity of 95% for 240 hours. The other sample was preserved at a temperature of 60° C. and a humidity of 95% for 380 hours. No crack was found in the layer to be peeled 1005 in either sample by observation with an optical microscope (hereinafter also referred to as microscopic observation) after the preservation. This result showed that the layer to be peeled 1005 of this example was less likely to generate a crack even when the sample was preserved in a high-temperature or high-humidity environment.

Note that in some cases, even when a crack was not observed at peeling in the layer to be peeled having small compressive stress (stress of approximately −15 MPa), a crack was observed in the layer to be peeled by microscopic observation after the preservation at a temperature of 60° C. and a humidity of 95% for 180 hours. From this result, in particular, the layer to be peeled 1005 of this example was less likely to generate a crack even when the samples were preserved in a high-temperature or high-humidity environment because the compressive stress was high.

Next, the flexible sample A after being preserved in the above environment for 240 hours was subjected to 2500-time bending with a radius of curvature of 5 mm. As illustrated in FIG. 12C, the radius of curvature for bending a sample 99 (corresponding to the sample A) was determined by the diameter of a metal rod 98 in the bending test.

In this example, a bending test was carried out in which the radius of curvature for bending the sample A was determined to be 5 mm by using the rod 98 having a 10-mm-diameter.

No crack was found in the layer to be peeled 1005 by microscopic observation after the bending test. This result showed that the layer to be peeled 1005 of this example was less likely to generate a crack even when the sample was bent.

In the flexible sample B, the layer to be peeled 1005 and the anisotropic conductive film 1151 having a thickness of 35 μm were pressure-bonded to each other. Three types of flexible samples B were prepared. The pressures of pressure bond heads 1155 were 0.25 MPa, 0.35 MPa, and 0.45 MPa.

As illustrated in FIG. 12D, a silicone rubber 1153 having a thickness of 200 μm was provided between the pressure bond head 1155 and the anisotropic conductive film 1151. Pressure-bonding was performed at 250° C. for 20 seconds.

When an FPC and the like are pressure-bonded, force is likely to be applied to a boundary portion between the layer to be peeled 1005 and the anisotropic conductive film 1151; thus, a crack is likely to occur in the layer to be peeled 1005. No crack was found in the layer to be peeled 1005 in the flexible sample B of this example by microscopic observation after pressure-bonding, regardless of the pressure of the pressure bond head. This result showed that the layer to be peeled 1005 of this example was less likely to generate a crack by pressure bonding.

As described above, it was found that the layer to be peeled 1005 of this example was less likely to generate a crack at peeling or pressure-bonding of an FPC, in a preservation test or a bending test after peeling, or the like. The layer to be peeled 1005 of this example is used as the insulating layer 105 and/or the insulating layer 115 described in any of the above embodiments, whereby occurrence of a crack can be inhibited and thus the reliability of the device can be improved. Moreover, it is suggested that occurrence of a crack in the layer to be peeled 1005 was inhibited because the layer to be peeled 1005 had compressive stress. In particular, the compressive stress of the layer to be peeled 1005 was preferably as high as possible.

### Example 2

In this example, an insulating layer that can be used in one embodiment of the present invention will be described. Specifically, the structure of the insulating layer that can be favorably used as the insulating layer 105 and/or the insulating layer 115 described in Embodiment 1 is described.

In the light-emitting device of one embodiment the present invention, it is necessary that at least one of the insulating layers 105 and 115 transmit light emitted from the light-emitting element because the light-emitting element is formed between the insulating layer 105 and the insulating layer 115. For example, in the light-emitting device in FIG. 1D, it is necessary that the insulating layer 115 transmit light from the light-emitting element. Therefore, an insulating layer in which transmittance of light in a visible region is high and cracks are less likely to occur is preferable as the insulating layer 105 and/or the insulating layer 115.

Thus, in this example, a stacked-layer structure in which the transmittance of light in a visible region is high was calculated and samples having the stacked-layer structure were actually fabricated to evaluate transmittance of light and unlikelihood of crack generation.

For the calculation, thin film calculation software, Essential Macleod (Thin Film Center Inc.), was used.

In the calculation, it was supposed that the stacked-layer structure is formed between a pair of layers having a refractive index of 1.500. The pair of layers having a refractive index of 1.500 is illustrated as a layer 1201 and a layer 1211 in FIG. 12E. The layer 1201 and the layer 1211 correspond to the film used for the substrate 1001 and the film used for the substrate 1011 in Example 1, respectively. The stacked-layer structure is a stack of three layers of a layer 1203, a layer 1205, and a layer 1207 in FIG. 12E, which are also collectively referred to as the layer to be peeled 1005.

The layer 1203 has a refractive index of 1.479 and a thickness of 600 nm, which corresponds to the first silicon oxynitride film in Example 1.

The layer 1205 has a refractive index of 1.898 and a thickness greater than or equal to 200 nm, which corresponds to the first silicon nitride film in Example 1.

The structure of the layer 1207 is different depending on the sample. In a sample 1, the structure and thickness of the layer 1207 were decided so that the entire stacked-layer structure corresponds to those of the layer to be peeled 1005 in Example 1. A sample 2 does not include the layer 1207. In each of samples 3, 4, 5, 6, 7, and 8, an optimum thickness of the layer 1207 was calculated.

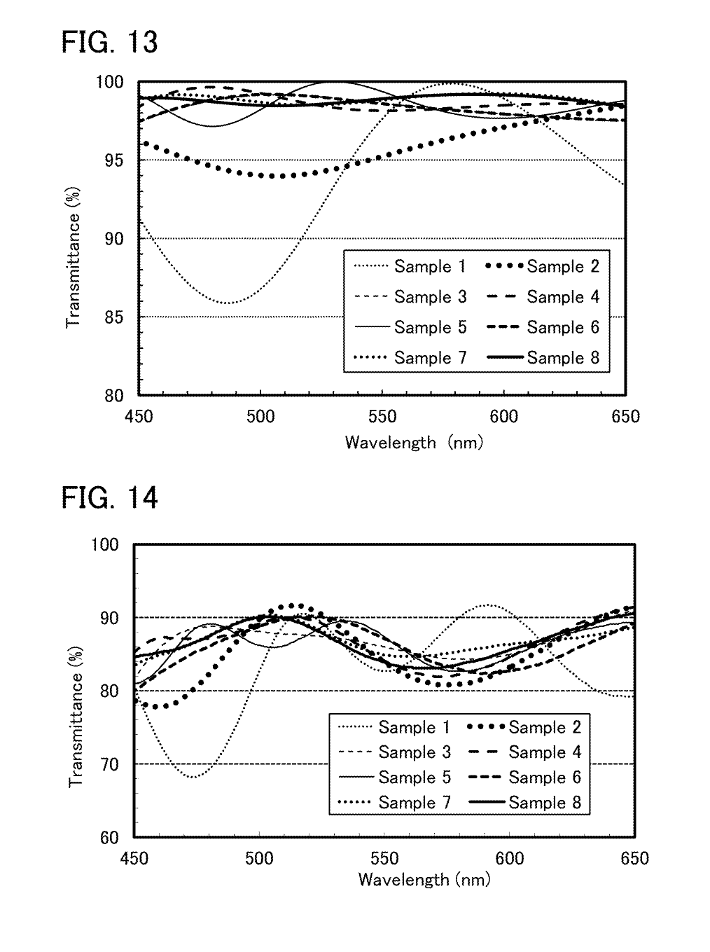

Table 2 shows the structure of the layer 1207 in each sample, a calculated optimum thickness of each layer (except for the samples 1 and 2), and average transmittance of light in a visible region (in a wavelength of 450 nm or more and 650 nm or less). In Table 2, the upper rows refer to the samples 1 to 4 and the lower rows refer to the samples 5 to 8. Furthermore, FIG. 13 shows transmittance of light obtained by calculation.

TABLE 2

| | | Sample 1 | Sample 2 | Sample 3 | Sample 4 | Sample 5 | Sample 6 | Sample 7 | Sample 8 |
|---|---|---|---|---|---|---|---|---|---|
| Transmittance (%) | | 93.74 | 95.83 | 98.35 | 98.68 | 98.42 | 98.35 | 98.90 | 98.83 |
| | Refractive index | Thickness (nm) | | | | | | | |
| Layer 1207 | 1.898 | — | — | — | — | — | — | — | 23 |
| | 1.469 | 100 | — | — | — | 190 | 20 | 100 | 30 |
| | 1.898 | 100 | — | 31 | 28 | 140 | 32 | 20 | 70 |
| | 1.474 | 200 | — | 22 | 33 | 180 | 23 | 34 | 5 |
| Layer 1205 | 1.898 | 200 | 200 | 200 | 290 | 280 | 200 | 280 | 200 |
| Layer 1203 | 1.479 | 600 | 600 | 600 | 600 | 600 | 600 | 600 | 600 |

The sample 1 and the samples 5 to 7 are each an example in which the layer 1207 has a three-layer structure, in which a layer having a refractive index of 1.474 (corresponding to the second silicon oxynitride film in Example 1), a layer having a refractive index of 1.898 (corresponding to the second silicon nitride film in Example 1), and a layer having a refractive index of 1.469 (corresponding to the third silicon oxynitride film in Example 1) are stacked on the layer 1205 side.

The samples 3 and 4 are each an example with the layer 1207 having a two-layer structure, which corresponds to the above three-layer structure from which the layer having a refractive index of 1.469 was removed.

The sample 8 is an example with the layer 1207 having a four-layer structure, which corresponds to the above three-layer structure on which another layer having a refractive index of 1.898 was further stacked. The layer having a refractive index of 1.898 corresponds to a film similar to the first silicon nitride film or the second silicon nitride film in Example 1.

The layer having a refractive index of approximately 1.5 and the layer having a refractive index of approximately 1.9 are alternately stacked so that antiphase interference occurs more often in the visible region, whereby the layer to be peeled 1005 can have higher transmittance of light in the visible region.

In the samples 1 to 8, transmittance of light in a visible region is greater than or equal to 93% on the average, which shows that a high transmitting property with respect to visible light. Moreover, in the samples 2 to 8, the transmittance of light in the visible region is greater than or equal to 90% on the average and, in the samples 3 to 8, the transmittance of light in the visible region is further greater than or equal to 95% on the average, which show a particularly high transmitting property with respect to visible light.

Next, the samples 1 to 8 were actually fabricated and transmittance of light in each sample was measured using a spectrophotometer.

A method for fabricating the samples 1 to 8 (FIG. 12F) to measure transmittance is described.

First, in a manner similar to that of Example 1, the base film and the peeling layer 1103 were formed in this order over the formation substrate 1101. Then, in this example, without performing N₂O plasma treatment after the formation of the peeling layer 1103, the layer to be peeled 1005 was formed over the peeling layer 1103. Note that in this example, the peeling layer 1103 and the layer 1203 were processed into an island-like shape by a dry etching method.

As the layer to be peeled 1005, the layers 1203, 1205, and 1207 in each sample in Table 2 were formed. Since each layer corresponds to any one of the layers included in the layer to be peeled 1005 formed in Example 1, Example 1 can be referred to for deposition conditions.

After that, heat treatment was performed at 450° C. in a nitrogen atmosphere for one hour. Then, the layer to be peeled 1005 was peeled from the formation substrate 1101 and the exposed layer to be peeled 1005 and the substrate 1001 were attached to each other with the bonding layer 1003.

The samples were irradiated with light from the substrate 1001 side to measure transmittance.

Table 3 shows average transmittance of light in a visible region (in a wavelength of 450 nm or more and 650 nm or less) in each sample. FIG. 14 shows the measured transmittance of light in each sample.

Table 3 shows the measured stress of the layer to be peeled in each sample. A method for fabricating samples used to measure stress is the same as that in Example 1.

TABLE 3

| | Sample 1 | Sample 2 | Sample 3 | Sample 4 | Sample 5 | Sample 6 | Sample 7 | Sample 8 |
|---|---|---|---|---|---|---|---|---|
| Transmittance (%) | 82.80 | 85.13 | 86.80 | 86.71 | 86.39 | 85.92 | 86.85 | 86.64 |
| Stress (Mpa) | −139 | −118 | −143.7 | −138.6 | −132.9 | −131.6 | −135.7 | −129.9 |

In the samples 1 to 8, transmittance of light in a visible region was greater than or equal to 82% on the average, which showed a high transmitting property with respect to visible light. Moreover, in the samples 2 to 8, the transmittance of light in the visible region was greater than or equal to 70% and, in the samples 3 to 8, the transmittance of light in the visible region was further greater than or equal to 80%, which showed a particularly high transmitting property with respect to visible light.

It was found that each of the samples 1 to 8 had compressive stress. Accordingly, it was suggested that cracks were less likely to be generated at peeling or pressure-bonding of an FPC, in a preservation test or a bending test after peeling, or the like.

Actually, whether a crack occurs or not in each sample by, for example, preserving the samples in a high-temperature and high-humidity environment or pressure-bonding an anisotropic conductive film was checked. A method for fabricating the samples 1 to 8 to check whether a crack occurs or not in each sample is described.

First, in a manner similar to that of Example 1, the base film and the peeling layer 1103 were formed in this order over the formation substrate 1101. Then, N₂O plasma treatment was performed, and the layer to be peeled 1005 was formed over the peeling layer 1103. After that, heat treatment was performed at 450° C. in a nitrogen atmosphere for one hour. Then, the layer to be peeled 1005 was attached to the substrate 1011 with the bonding layer 1013 (see FIG. 12A). The materials of the substrate 1011 and the bonding layer 1013 are the same as those in Example 1.

Next, the layer to be peeled 1005 was peeled from the formation substrate 1101. In the layer to be peeled 1005 which was peeled, a crack that can be recognized with eyes did not occur in any sample.

It is considered that the layer to be peeled 1005 in each of the samples 1 to 8 is less likely to generate a crack at peeling because of having compressive stress.

Furthermore, the layer to be peeled 1005 was exposed by peeling the formation substrate 1101. In the following description, two types of flexible samples were fabricated. One kind of the samples is flexible samples 1A, 2A, 3A, 4A, 5A, 6A, 7A, and 8A in each of which the exposed layer to be peeled 1005 and the substrate 1001 were attached to each other with the bonding layer 1003 (see FIG. 12B). The other kind of the samples is flexible samples 1B, 2B, 3B, 4B, 5B, 6B, 7B, and 8B in each of which an anisotropic conductive film 1151 was provided over the exposed layer to be peeled 1005 (see FIG. 12D). Note that the flexible samples 1B to 8B were each in a state with a protective film of a film used for the substrate 1011 (the protective film is also referred to as a separate film and, here, is a 100-μm-thick film).

The flexible samples 1A to 8A were each subjected to a preservation test. Note that the same material as the bonding layer 1013 was used for the bonding layer 1003, and the same material as the substrate 1011 was used for the substrate 1001.

The samples 1A to 8A were preserved at a temperature of 60° C. and a humidity of 95% for 240 hours. No crack was found in the layer to be peeled 1005 in any sample by microscopic observation after the preservation. It is considered that the layer to be peeled 1005 in each of the samples 1A to 8A is less likely to generate a crack even when the samples were preserved in a high-temperature or high-humidity environment because of having compressive stress.

In each of the flexible samples 1B to 8B, the layer to be peeled 1005 and the anisotropic conductive film 1151 were pressure-bonded to each other. Three types of flexible samples 1B to 8B were prepared. The pressures of pressure bond heads 1155 were 0.25 MPa, 0.35 MPa, and 0.45 MPa. Other conditions are the same as those in Example 1.

When microscopic observation was performed after pressure-bonding, the number of cracks that occurred in each sample was greater than or equal to 0 and less than or equal to 3, regardless of the pressure of the pressure bond head. It is considered that the layer to be peeled 1005 in each of the samples 1B to 8B is less likely to generate a crack due to pressure-bonding because of having compressive stress. The cracks due to pressure-bonding were particularly less likely to occur as the compressive stress of the layer to be peeled 1005 became higher. Accordingly, it was found that the crack due to pressure-bonding is inhibited and thus the reliability of the device can be improved as the compressive stress of the layer to be peeled 1005 becomes higher.

As described above, it was found that the samples of this example is less likely to generate a crack in the layer to be peeled 1005 at peeling or pressure-bonding of an FPC, in a preservation test or a bending test after peeling, or the like. Furthermore, it was found that the samples of this example each have high transmittance of light in the visible region.

The layer to be peeled 1005 of this example is used as the insulating layer 105 and/or the insulating layer 115 described in any of the above embodiments, whereby occurrence of a crack can be inhibited and thus the reliability of the device can be improved. Since the layer to be peeled 1005 of this example has high transmittance of light in a visible region, the layer to be peeled 1005 can be favorably used as the insulating layer provided on the side where light emission of the light-emitting element is extracted.

### Example 3

In this example, results of a preservation test carried out on the light-emitting device of one embodiment of the present invention will be described.

In this example, the light-emitting device of one embodiment of the present invention was preserved in a high-temperature and high-humidity environment while being bent.

The light-emitting device fabricated in this example is a 3.4-inch sized flexible organic EL display with a definition of 326 ppi and a resolution of QHD (Quarter Full High Definition) (960×540×RGB).

A method for fabricating the light-emitting device of this example is described.

First, a peeling layer was formed over each of two formation substrates, and a layer to be peeled was formed over each peeling layer. Next, the two formation substrates were attached to each other so that the surfaces on which the layers to be peeled are formed face each other. Then, the two formation substrates were peeled from the respective layers to be peeled, and flexible substrates were attached to the respective layers to be peeled. In the above manner, the light-emitting device illustrated in FIG. 1A1 and FIG. 2A was fabricated. Materials for each of the layers are described below.

Glass substrates were used as the formation substrates. A stacked-layer structure of a tungsten film and a tungsten oxide film thereover was formed as each of the peeling layers. Specifically, an approximately 30-nm-thick tungsten film was formed by a sputtering method and subjected to N₂O plasma treatment, and then a layer to be peeled was formed.

The peeling layer having the stacked-layer structure right after deposition is not easily peeled; however, by reaction with an inorganic insulating film by heat treatment, the state of the interface between the peeling layer and the inorganic insulating film is changed to become brittle. Then, forming a peeling starting point enables physical peeling.

As the layer to be peeled, the insulating layer 105 and the element layer 106a were formed over one of the formation substrates. The insulating layer 115 and the functional layer 106b were formed as the layer to be peeled over the other formation substrate.

As the element layer 106a, a transistor, an organic EL element serving as the light-emitting element 830, and the like were formed. As the functional layer 106b, a color filter (e.g., the coloring layer 845), a black matrix (e.g., the light-blocking layer 847), or the like was formed.

As the transistor, a transistor including a c-axis aligned crystalline oxide semiconductor (CAAC-OS) was used. Since the CAAC-OS, which is not amorphous, has few defect states, using the CAAC-OS can improve the reliability of the transistor. Moreover, since the CAAC-OS does not have a grain boundary, stress that is caused by bending a flexible light-emitting device does not easily generate a crack in a CAAC-OS film.

A CAAC-OS is an oxide semiconductor having c-axis alignment in a direction perpendicular to the film surface. It has been found that oxide semiconductors have a variety of crystal structures other than an amorphous structure and a single-crystal structure. An example of such structures is a nano-crystal (nc)-OS, which is an aggregate of nanoscale microcrystals. The crystallinity of the CAAC-OS is lower than that of a single crystal structure but higher than those of an amorphous structure and an nc-OS structure.

In this example, a channel-etched transistor including an In—Ga—Zn-based oxide was used. The transistor was fabricated over a glass substrate at a process temperature lower than 500° C.

In a method for fabricating an element such as a transistor directly on an organic resin such as a plastic substrate, the temperature of the process for fabricating the element needs to be lower than the heat-resistant temperature of the organic resin. In this example, the formation substrate is a glass substrate and the peeling layer, which is an inorganic film, has high heat resistance; thus, the transistor can be fabricated at a temperature equal to that when a transistor is fabricated over a glass substrate. Thus, the performance and reliability of the transistor can be easily secured.

As the light-emitting element 830, a tandem organic EL element that included a fluorescence-emitting unit including a blue light-emitting layer and a phosphorescence-emitting unit including a green light-emitting layer and a red light-emitting layer was used. The light-emitting element 830 is a top-emission light-emitting element.

The structures of the insulating layer 105, the insulating layer 115, the bonding layer 103, the bonding layer 107, the bonding layer 113, the substrate 101, and the substrate 111 were each different depending on the samples.

In the sample 1 and the sample 2, a structure and a formation method the same as those of the layer to be peeled 1005 formed in Example 1 were used for the insulating layer 115. Further, in the sample 1 and sample 2, a structure and a formation method the same as those of the layer to be peeled 1005 formed in Example 1 were used for the insulating layer 105 except for the following points. In the insulating layer 105, the second silicon nitride film was replaced with an approximately 140-nm-thick silicon nitride oxide film. The silicon nitride oxide film was formed by a plasma CVD method under the following conditions: the flow rates of a silane gas, an H₂ gas, an N₂ gas, an NH₃ gas, and an N₂O gas were 110 sccm, 800 sccm, 800 sccm, 800 sccm, and 70 sccm, respectively, the power supply was 320 W, the pressure was 100 Pa, and the substrate temperature was 330° C. The stress of the insulating layer 105 with the above structure was −15 MPa when measured by a method similar to that in Example 1.

In the sample 1, a thermosetting adhesive having a glass transition temperature of approximately 100° C. was used for the bonding layers 103, 107, and 113. In the sample 2, a thermosetting adhesive having a glass transition temperature of approximately 100° C. was used for the bonding layer 107 and an ultraviolet curable adhesive having a glass transition temperature of approximately 150° C. was used for the bonding layers 103 and 113.

In a comparative sample, the same structure as the insulating layer 105 in the sample 1 was used for both the insulating layer 105 and the insulating layer 115. An adhesive having a glass transition temperature lower than 60° C. was used for the bonding layers 103, 107, and 113.

In each of the samples 1 and 2 and the comparative sample, an organic resin film having a coefficient of linear expansion less than or equal to 20 ppm/K was used as the substrate 101 and the substrate 111, though the materials of the organic resin films were different. In the sample 2, since the ultraviolet curable adhesive was used for the bonding layers 103 and 113, a film that transmits ultraviolet light was used.

Furthermore, a reliability test was carried out on the fabricated light-emitting device. In the reliability test, the light-emitting device was preserved at a temperature of 65° C. and a humidity of 95% for 1000 hours while being bent with the radius of curvature of 5 mm and an image being displayed.

The radius of curvature for bending each sample was determined by the rod 98 used in the bending test of Example 1 (see the view on the right side in FIG. 12C). At this time, a bent portion is a middle portion of the light-emitting device and includes a light-emitting portion and a scan driver. In this example, the bending test was carried out such that a display surface of the light-emitting device faces outward.

In the samples 1 and 2, the display portion had no defect such as a crack and the driver operated normally even after 1000 hours. There was almost no shrinkage (here, luminance decay in the end portion of the light-emitting portion or a bent portion or expansion of a non-light-emitting region of the light-emitting portion). Specifically, when microscopic observation was performed on the end portion of the light-emitting portion in the sample 1 and the bent portion and the end portion of the light-emitting portion in the sample 2, almost no luminance decay was found.

In contrast, in the comparative sample, a display defect due to a crack was generated within 100 hours.

According to this example, it was found that the use of one embodiment of the present invention enabled a light-emitting device to be used for a long time while being bent. Moreover, it was found that generation of a crack and shrinkage in the display portion can be inhibited with application of one embodiment of the present invention as compared with the case of using an insulating layer having tensile stress or an insulating layer having a low glass transition temperature.

This application is based on Japanese Patent Application serial no. 2014-111985 filed with Japan Patent Office on May 30, 2014 and Japanese Patent Application serial no. 2014-142077 filed with Japan Patent Office on Jul. 10, 2014, the entire contents of which are hereby incorporated by reference.

What is claimed is:

1. A light-emitting device comprising:
a first substrate which is flexible;
a second substrate which is flexible;
an element layer comprising a light-emitting element, the element layer between the first substrate and the second substrate;
a first insulating layer between the first substrate and the element layer;
a second insulating layer between the second substrate and the element layer;
a first bonding layer between the first substrate and the first insulating layer; and
a second bonding layer between the second substrate and the second insulating layer,
wherein the first insulating layer comprises a first portion,
wherein the second insulating layer comprises a second portion,
wherein the first bonding layer comprises a third portion,
wherein the second bonding layer comprises a fourth portion,
wherein the first substrate comprises a fifth portion,
wherein the second substrate comprises a sixth portion,
wherein at least one of the first portion and the second portion has compressive stress,
wherein a glass transition temperature of at least one of the third portion and the fourth portion is higher than or equal to 60° C., and
wherein a coefficient of linear expansion of at least one of the fifth portion and the sixth portion is less than or equal to 60 ppm/K.

2. The light-emitting device according to claim 1,
wherein the first bonding layer comprises a seventh portion,
wherein the second bonding layer comprises an eighth portion, and
wherein a coefficient of linear expansion of at least one of the seventh portion and the eighth portion is less than or equal to 100 ppm/K.

3. The light-emitting device according to claim 1,
wherein the first substrate comprises a ninth portion,
wherein the second substrate comprises a tenth portion, and
wherein a glass transition temperature of at least one of the ninth portion and the tenth portion is higher than or equal to 150° C.

4. The light-emitting device according to claim 1,
wherein the first substrate comprises an eleventh portion,
wherein the second substrate comprises a twelfth portion, and
wherein a thickness of at least one of the eleventh portion and the twelfth portion is greater than or equal to 1 μm and less than or equal to 25 μm.

5. The light-emitting device according to claim 1, wherein stress of at least one of the first portion and the second portion is higher than or equal to −250 MPa and lower than or equal to −15 MPa.

6. The light-emitting device according to claim 1,
wherein the first insulating layer comprises a thirteenth portion,
wherein the second insulating layer comprises a fourteenth portion, and
wherein transmittance of light in a visible region in at least one of the thirteenth portion and the fourteenth portion is greater than or equal to 80% on average.

7. The light-emitting device according to claim 6, wherein transmittance of light having a wavelength of 475 nm in at least one of the thirteenth portion and the fourteenth portion is greater than or equal to 80%.

8. The light-emitting device according to claim 6, wherein transmittance of light having a wavelength of 650 nm in at least one of the thirteenth portion and the fourteenth portion is greater than or equal to 80%.

9. The light-emitting device according to claim 1, wherein at least one of the first insulating layer and the second insulating layer comprises oxygen, nitrogen, and silicon.

10. The light-emitting device according to claim 1, wherein at least one of the first insulating layer and the second insulating layer comprises silicon nitride or silicon nitride oxide.

11. The light-emitting device according to claim 1,
wherein at least one of the first insulating layer and the second insulating layer comprises a silicon oxynitride film and a silicon nitride film, and
wherein the silicon oxynitride film and the silicon nitride film are in contact with each other.

12. The light-emitting device according to claim 1,
wherein the first insulating layer comprises:
a first silicon oxynitride film;
a first silicon nitride film on and in contact with the first silicon oxynitride film;
a second silicon oxynitride film on and in contact with the first silicon nitride film;
a second silicon nitride film on and in contact with the second silicon oxynitride film; and
a third silicon oxynitride film on and in contact with the second silicon nitride film.

13. The light-emitting device according to claim 12,
wherein the second insulating layer comprises:
a fourth silicon oxynitride film;
a third silicon nitride film on and in contact with the fourth silicon oxynitride film;
a fifth silicon oxynitride film on and in contact with the third silicon nitride film;
a fourth silicon nitride film on and in contact with the fifth silicon oxynitride film; and
a sixth silicon oxynitride film on and in contact with the fourth silicon nitride film.

14. The light-emitting device according to claim 1,
wherein the second insulating layer comprises:
a first silicon oxynitride film;
a first silicon nitride film on and in contact with the first silicon oxynitride film;
a second silicon oxynitride film on and in contact with the first silicon nitride film;
a second silicon nitride film on and in contact with the second silicon oxynitride film; and
a third silicon oxynitride film on and in contact with the second silicon nitride film.

15. An electronic device comprising:
the light-emitting device according to claim 1, and
an antenna, a battery, a housing, a speaker, a microphone, or an operation button.

16. A light-emitting device comprising:
a first substrate which is flexible;
a second substrate which is flexible;
an element layer comprising a light-emitting element, the element layer between the first substrate and the second substrate;
a first insulating layer between the first substrate and the element layer;
a second insulating layer between the second substrate and the element layer;
a first bonding layer between the first substrate and the first insulating layer; and
a second bonding layer between the second substrate and the second insulating layer,
wherein the first insulating layer comprises:
a first silicon oxynitride film;
a first silicon nitride film on and in contact with the first silicon oxynitride film;
a second silicon oxynitride film on and in contact with the first silicon nitride film;
a second silicon nitride film on and in contact with the second silicon oxynitride film; and
a third silicon oxynitride film on and in contact with the second silicon nitride film,
wherein the first insulating layer comprises a first portion,
wherein the second insulating layer comprises a second portion,
wherein the first bonding layer comprises a third portion,
wherein the second bonding layer comprises a fourth portion,
wherein the first substrate comprises a fifth portion,
wherein the second substrate comprises a sixth portion,
wherein a glass transition temperature of at least one of the third portion and the fourth portion is higher than or equal to 60° C., and
wherein a coefficient of linear expansion of at least one of the fifth portion and the sixth portion is less than or equal to 60 ppm/K.

17. The light-emitting device according to claim 16,
wherein the first bonding layer comprises a seventh portion,
wherein the second bonding layer comprises an eighth portion, and
wherein a coefficient of linear expansion of at least one of the seventh portion and the eighth portion is less than or equal to 100 ppm/K.

18. The light-emitting device according to claim 16,
wherein the first substrate comprises a ninth portion,
wherein the second substrate comprises a tenth portion, and
wherein a glass transition temperature of at least one of the ninth portion and the tenth portion is higher than or equal to 150° C.

19. The light-emitting device according to claim 16,
wherein the first substrate comprises an eleventh portion,
wherein the second substrate comprises a twelfth portion, and
wherein a thickness of at least one of the eleventh portion and the twelfth portion is greater than or equal to 1 μm and less than or equal to 25 μm.

20. The light-emitting device according to claim 16, wherein stress of at least one of the first portion and the second portion is higher than or equal to −250 MPa and lower than or equal to −15 MPa.

21. The light-emitting device according to claim 16,
wherein the first insulating layer comprises a thirteenth portion,
wherein the second insulating layer comprises a fourteenth portion, and
wherein transmittance of light in a visible region in at least one of the thirteenth portion and the fourteenth portion is greater than or equal to 80% on average.

22. The light-emitting device according to claim 21, wherein transmittance of light having a wavelength of 475 nm in at least one of the thirteenth portion and the fourteenth portion is greater than or equal to 80%.

23. The light-emitting device according to claim 21, wherein transmittance of light having a wavelength of 650 nm in at least one of the thirteenth portion and the fourteenth portion is greater than or equal to 80%.

24. The light-emitting device according to claim 16, wherein at least one of the first insulating layer and the second insulating layer comprises oxygen, nitrogen, and silicon.

25. The light-emitting device according to claim 16,
wherein the second insulating layer comprises:
a fourth silicon oxynitride film;
a third silicon nitride film on and in contact with the fourth silicon oxynitride film;
a fifth silicon oxynitride film on and in contact with the third silicon nitride film;
a fourth silicon nitride film on and in contact with the fifth silicon oxynitride film; and
a sixth silicon oxynitride film on and in contact with the fourth silicon nitride film.

26. An electronic device comprising:
the light-emitting device according to claim 16, and
an antenna, a battery, a housing, a speaker, a microphone, or an operation button.
